(19) United States
(12) Patent Application Publication
(10) Pub. No.: US 2006/0103667 A1
(43) Pub. Date: May 18, 2006

(54) Method, system and computer readable code for automatic reize of product oriented advertisements

(75) Inventors: Aviel Amit, Holon (IL); Margarita Panova, Tel-Aviv (IL); Adi Gotshal, Givataim (IL); Itamar Avraham, Kiryat-Ono (IL)

Correspondence Address: DR. MARK FRIEDMAN LTD.;c/o Bill Polkinghorn, 9003 Florin Way, Upper Marlboro, MD, 20772, US

(73) Assignee: Universal-Ad. Ltd.

(21) Appl. No.: 11/260,085

(22) Filed: Oct. 28, 2005

Related U.S. Application Data
(60) Provisional application No. 60/622,585, filed on Oct. 28, 2004.

(51) Int. Cl. G09G 5/00; G06F 17/21; G06F 17/00

(52) U.S. Cl. 345/619; 715/517; 715/788

(57) ABSTRACT

A system, method and computer readable code for re-sizing (e.g. shifting and re-scaling) graphical objects is disclosed. According to some embodiments, a layout engine differentially re-sizes different groups of graphical object in accordance with different re-size parameters. According to some embodiments, the layout engine re-sizes graphical objects in accordance with defined delta re-size parameters and proportional re-size parameters. According to some embodiments, the re-sizing includes a hierarchical re-sizing of an embedded inner graphical object having inner re-size parameters. A system, method and computer readable code for laying out a target graphic object within a bounding frame in accordance with at least one of free frame layout parameter and a ventilation parameter is disclosed.

This patent application claims the benefit of U.S. Provisional Patent Application No. 60/622,585, filed on Oct. 28, 2004.

### FIELD OF THE INVENTION

Embodiments of the present invention generally relate to methods, systems and computer readable code for the layout of objects including graphical layout objects in visual media including but not limited to advertisements.

### BACKGROUND OF THE INVENTION

Product oriented ads are often implemented in free-standing-inserts, flyers, coupons-sheet, catalogs and shelf-talkers, and are widely produced by retailers, manufacturers and distributors on reoccurring bases. These advertisements are sale aimed; they consist of product information, copy, images, graphics, promotion details, logos, prices and other marketing related information.

The ads are distributed through several distribution channels including newspapers, newsletters, print, web, video, email, cellular devices and more. Each channel has its own presentation factors. One exemplary presentation factor is the page size, which imposes constraints on the page layout and the ad layout.

As the customer facing information is changing frequently, publishers & advertisers create a large number of variations or versions of each advertisements with a given corpus of advertisements. For example, many supermarket chains produce slightly different variations of essentially the same store flyer for a variety of stores, where there could be for example slight discrepancies in the number of featured products. Another example is a merchandiser that produces different versions of the same catalogue, where the actual products, number of products, and prices may change between catalogues, but there is a need to preserve the graphical “look and feel”

When there is a need to distribute an ad using several different presentation media or several versions of the same ad in a single presentation media, the page and the ad must be built several times, each time with different presentation factors such as size parameters.

Today the demand for customization and personalization of the advertisements as well as web sites such as corporate web sites increases while the production time frame is getting shorter and, there is a need for tools that can automate the creation of the content, and the page or ad layout.

One motivating factor driving the need for this customization and personalization is that many organizations have large amounts of textual and graphical data resident in databases that needs to be layout in appropriate graphical media.

Existing Solutions

Static layout templates are a common solution employed by many applications. Static layout templates automate final advertisement production according to a predefined design, and thus reduce the cost of manually layout of advertisements.

One problem with the static layout templates is that static template based ads have a rigid size and look resulting in technical appearance rather than a desired promotional appearance. This is due to a tendency to place graphical elements only according to size and location specified in the static layout template.

Another limitation of that solution is that page size and ad sizes must be determined in advanced, this avoid the use of templates in situations where ad or page size are not known in advance or might frequently change.

It is common for merchants or other entities to distribute A3 or tabloid free-standing-inserts, where each page might include several sub pages (such as several sections or departments in one page) each sub-page with its own ads, look & feel, headers footers etc. The partition of the page into several sub-pages, and the size of each sub-page are determined according to the number of ads and the size of each ad in each sub-page. As a result, there is a need to rearrange and to resize elements of the page, the sub-pages and the ads according to size that is dynamically changed.

Another problem with static layout templates arises in case where one can predict the different sizes needed, and must satisfy a rich look & feel publication with many different ad models. The number of templates needed is the multiplication of the number of ad sizes (N), by the number of ad models (M), resulting in N×M static layout templates. When the number templates needed is high, or when ad size or ad model is frequently changes, then the creation and maintenance of templates is a costly issue that renders the use of static layout templates difficult to manage and cost-prohibitive. In the preceding paragraph, it is understood that this can apply to any graphical or textual element, and is not intended to be limited to advertisements.

In order to overcome these limitations there is a need for easy method to resize a layout templates. Resizing static templates by using a photographic scale-up or scale-down operator often yield poor results, as it does not preserve the text readability or the creative concept or “look and feel” of the template.

This problem is not limited to print ads. It is known in the art that views of web page receive a different image depending on the screen resolution or the dimensions allotted to a certain graphical layout region. In certain cases, producers of graphic-rich web sites prepare a number of versions of the same web page or web site, with each version providing optimal view for one or more screen resolution settings, or for one or more external dimensions allotted to a graphical frame, with an unfortunate drain of resources. There is an ongoing need for techniques and systems for automatically and semi-automatically producing from a single web page a series of web pages, with each web page optimized for viewing with different screen resolution parameters.

This problem is not limited to print ads. It is known in the art that views of web page receive a different image depending on the screen resolution or the dimensions allotted to a certain graphical layout region. In certain cases, producers of graphic-rich web sites prepare a number of versions of the same web page or web site, with each version providing optimal view for one or more screen resolution settings, or for one or more external dimensions allotted to a graphical frame, with an unfortunate drain of resources. There is an ongoing need for techniques and systems for automatically and semi-automatically producing from a single web page a series of web pages, with each web page optimized for viewing with different screen resolution parameters.

### SUMMARY OF THE INVENTION

The aforementioned needs are satisfied by several aspects of the present invention

Certain embodiments of the present invention provide a system and a method to automatically resize layout of templates, final pages, sub-pages and ads in manner that preserve the creative concept of the designer.

In accordance with several embodiments of the present invention, it has been observed that certain types of graphical media, particularly printed product oriented advertising flyers and product catalogs, exhibit certain recurring often surprising graphical patterns.

Study of graphical media including advertising flyers, newspapers, product catalogues and web sites has revealed to the present inventors a set of recurring graphical motifs. Exemplary graphical media studies is provided in FIGS. 1A and 1B. Embodiments of the present invention provide a set of specific resize and other layout altering parameters based upon these recurring graphical motifs. Further embodiments of the present invention facilitate the automatic and semiautomatic resizing and rearrangement of layout elements while preserving fundamental layout characteristics whose aggregate comprises a documents' “look and feel”. In specific embodiments, the use of these resize and other layout altering parameters allows for the production of a series of graphical media documents, thereby freeing human designers to focus more on the creative aspects of design rather than the tedious task of producing a plurality of graphically similar but non-identical graphical media documents.

It is now disclosed for the first time a system for graphical layout comprising
a) a model layout interface for defining positions and sizes of a plurality of graphical objects within a model outer frame;
b) a re-size parameter interface operative to define re-size parameters including shift parameters, scale parameters, proportion re-size parameters and delta re-size parameters for each said graphical object; and
c) a layout engine for shifting and scaling said graphical objects within a re-sized outer frame in accordance with at least one dimension of said model outer frame, at least one dimension of said re-sized outer frame, and said defined re-size parameters.

In some embodiments, the re-size parameter interface operative to define at least the following four re-size parameters for a given graphical object: delta scale, proportional (%) scale, delta shift and proportional (%) shift.

According to some embodiments, at least one said graphical object is a placeholder having inner graphical objects embedded therein, and said layout engine is operative to recursively effect a hierarchical re-sizing of said inner graphical objects in accordance with inner re-size parameters of said inner graphical objects relative to said re-sized placeholder.

According to some embodiments, the presently disclosed system further comprises a reference point interface for defining a reference point of at least one of said model outer frame and said graphical object, wherein said layout engine performs at least one of said shifting and said scaling in accordance with said defined reference point.

According to some embodiments, said reference point interface is operative for selecting said reference point from a plurality of discrete reference points.

According to some embodiments, said re-size parameter interface is operative to define variable re-size parameters whose value depends on a relation between dimensions of said model outer frame and said re-sized outer frame.

According to some embodiments, said layout engine is operative to perform re-sizing of static content (e.g. non-video still graphics). Alternatively or additionally, said layout engine is operative to perform re-sizing of video content.

According to some embodiments, one said re-sized graphical object is a placeholder having inner graphical objects embedded therein, and the system further comprises an alignment definition interface (e.g. one dimensional or multi—(e.g. two)—dimensional) for defining an alignment of said inner graphical object within said placeholder.

According to some embodiments, said layout engine is further operative to layout at least one said graphical object in accordance with layout score and optionally a disqualifier, and said layout score is determined by at least one of an object overlap parameter, a text background transparency status, an layout rotation angle (e.g. a re-orienting of the graphical object with respect to the outer bounding frame), a ventilation parameter, and a location of a weighted center of said graphical object relative to a center of a bounding frame (e.g. including but not limited to a rectangular frame).

It is now disclosed for the first time a system for layout of a target graphical object within a bounding frame, the system comprising:
a) a layout parameter calculation engine for calculating for at least one putative layout configuration at least one layout parameter selected from the group consisting of free frame layout parameter and a ventilation parameter; and
b) a layout engine for performing a layout (e.g. performing at least one of (or a plurality of) scaling, sizing and orienting) of said target graphical object within said bounding frame in accordance with a said calculated parameter.

According to some embodiments, said layout parameter calculation is performed for a plurality of putative layout configurations (selected in any manner known in the art, including but not limited to genetic algorithms), and the system further comprises selection engine for selecting configurations to score.

According to some embodiments, for a given putative layout configuration, said layout parameter calculation engine calculates a plurality of said layout parameters, said system further comprising:
c) a layout parameter combining engine for computing a layout score from said plurality of said layout parameters,
wherein said layout engine performs said layout in accordance with said layout score.

According to some embodiments, said layout engine is operative to prefer (for example, by assigning higher scores to) larger scalings of said target graphical object.

According to some embodiments, said layout parameter calculation engine is operative to calculate a re-orientation parameter of the target graphical object within said bounding frame, and said layout engine is operative to re-orient said target graphical object within said bounding frame.

According to some embodiments, said layout parameter calculation engine is operative to calculate at least one additional layout parameter selected from the group consisting of an object overlap parameter, a text background transparency status, relative color status (e.g. similarilty of hue, so, for example, black and white have an opposite color status which allows more overlap, while light red and pink have a more similar color status which precludes more overlap) of the target graphical object and a background (e.g. a background of the bounding frame or a local background of a region where a target graphical object is putatively placed) and said layout engine is further operative to perform said layout of said target graphical object within said bounding frame in accordance with a said calculated additional layout parameter.

It is now disclosed for the first time a system for graphical layout comprising:

a) a model layout interface for defining positions and sizes of a plurality of graphical objects within a model outer frame;
b) a differential layout engine for effecting a re-sizing including shifting and scaling of said graphical objects within a re-sized outer frame in accordance with at least one dimension of said model outer frame and at least one dimension of said re-sized outer frame,
wherein a first group of said graphical objects are re-sized according to a first set of re-sizing parameters, and a second group of said graphical objects are re-sized according to a second set of re-sizing parameters differing from said first set of re-sizing parameters.

According to some embodiments, said graphical objects include a first and second placeholder, each said placeholder having a respective group of inner graphical objects embedded therein, each said respective group of said inner graphical objects having a different set of inner re-size parameters, each said placeholder being subjected to a different re-sizing, and said layout engine is operative to recursively effect a hierarchical re-sizing of said respective inner graphical objects within each said respective placeholder in accordance with said respective inner re-size parameters.

According to some embodiments, said graphical objects include a first and second placeholder, each said placeholder having respective inner graphical objects embedded therein, each said placeholder being subjected to a different re-sizing, and said layout engine is operative to layout said inner graphical objects within each placeholder in accordance with at least one factor selected from the group consisting of an object overlap parameter, a text background transparency status, an orientational deviation between a putative orientation and a default or pre-assigned orientation, a ventilation parameter, and a location of a weighted center of said graphical object relative to a center of a bounding frame (including but not limited to a rectangular frame) and a relative color status of the target graphical object and a background (e.g. a background of the bounding frame or a local background of a region where a target graphical object is putatively placed).

It is now disclosed for the first time a method of graphical layout comprising:
a) defining positions and sizes of a plurality of graphical objects within a model outer frame;
b) defining re-size parameters including shift parameters, scale parameters, proportion re-size parameters and delta re-size parameters for each said graphical object; and
c) shifting and scaling said graphical objects within a re-sized outer frame in accordance with at least one dimension of said model outer frame, at least one dimension of said re-sized outer frame, and said defined re-size parameters.

It is now disclosed for the first time a method of layout of a target graphical object within a bounding frame, the system comprising:
a) calculating for at least one putative layout configuration at least one layout parameter selected from the group consisting of free frame layout parameter and a ventilation parameter; and
b performing a layout of said target graphical object within said bounding frame in accordance with a said calculated parameter.

It is now disclosed for the first time a method of graphical layout comprising:
a) defining positions and sizes of a plurality of graphical objects within a model outer frame; and
b) effecting a re-sizing including shifting and scaling of said graphical objects within a re-sized outer frame in accordance with at least one dimension of said model outer frame and at least one dimension of said re-sized outer frame,
wherein a first group of said graphical objects are re-sized according to a first set of re-sizing parameters, and a second group of said graphical objects are re-sized according to a second set of re-sizing parameters differing from said first set of re-sizing parameters.

### BRIEF DESCRIPTION OF THE FIGURES

FIGS. 1-20 provide images of exemplary re-sizings in accordance with exemplary embodiments of the present invention.

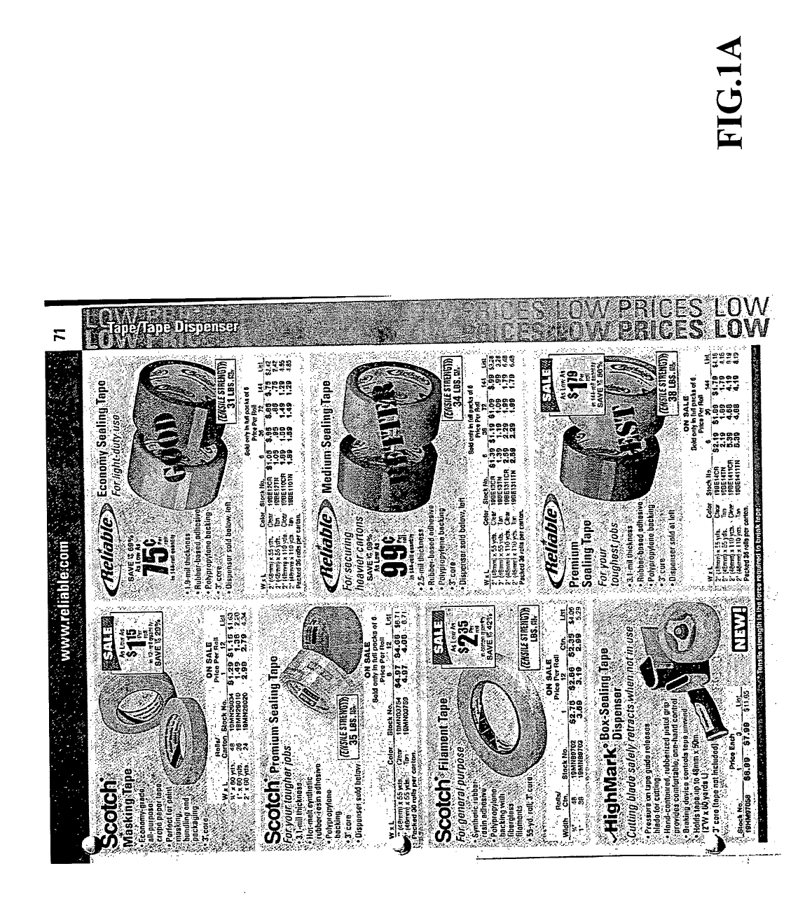

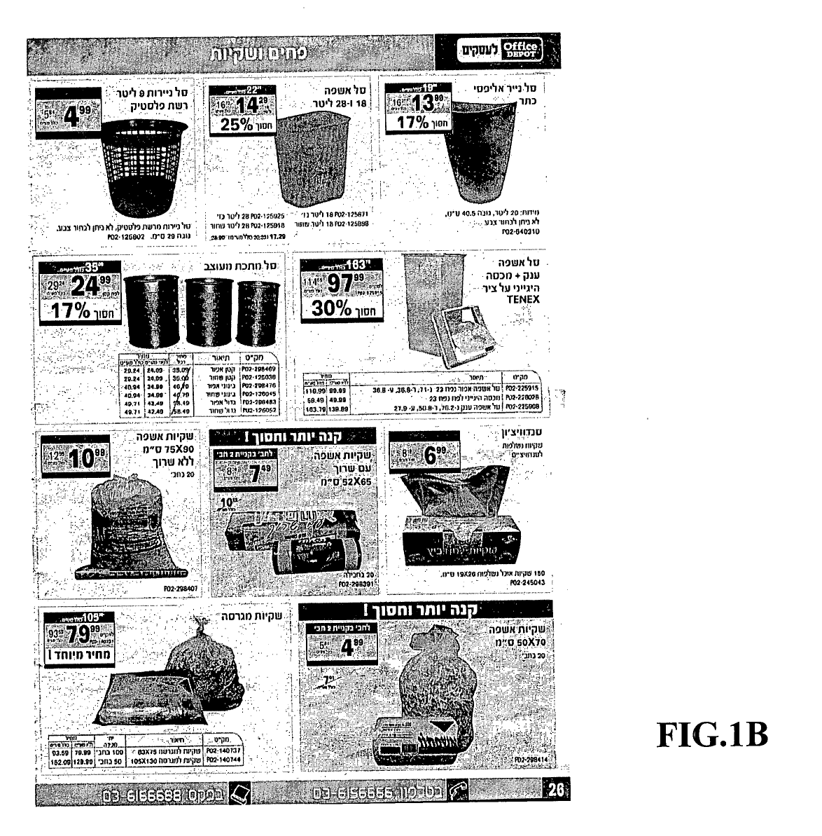

### DETAILED DESCRIPTION OF THE INVENTION

The numerous innovative teachings of the present application are described below with particular reference to an exemplary embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

Assuming an advertisement composed of one or more visible elements, such as title, description, Logo, Icon, image, table, Cell, and graphic, on a page organized and sized according to a graphic design made by a graphic designer, then changing the ad or page size might require changes in position and size of the visible elements of the ad or the page.

According to specific embodiments, the size of the ad or of the page changes with or without changing the aspect ratio of the ad or page. According to specific embodiments, this size change reflects differently on each object contained in that ad or page. Most well designed advertisements layouts are done by a human graphic designer, using design layout software, with respect to corporate identity and predefined graphic rules embedded into each advertisement. In specific embodiments, these relations should be preserved after the size and/or layout of various layout elements changes.

In certain embodiments of the present invention, at least some parameters define how to apply size change to each layout element according to a size change of its container. In this way, a hierarchical mechanism is defined and enables the creation and layout of complex multi-level content at many different sizes derived from page size or grid size or ad size all the way down up to the lowest level of layout element in an ad.

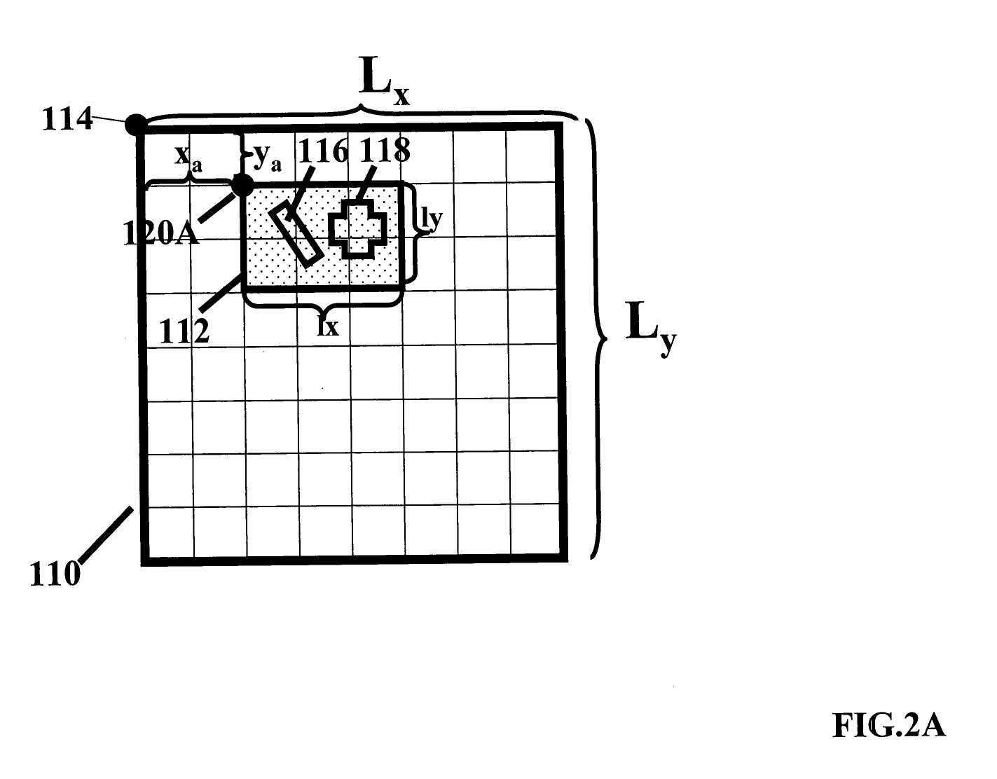

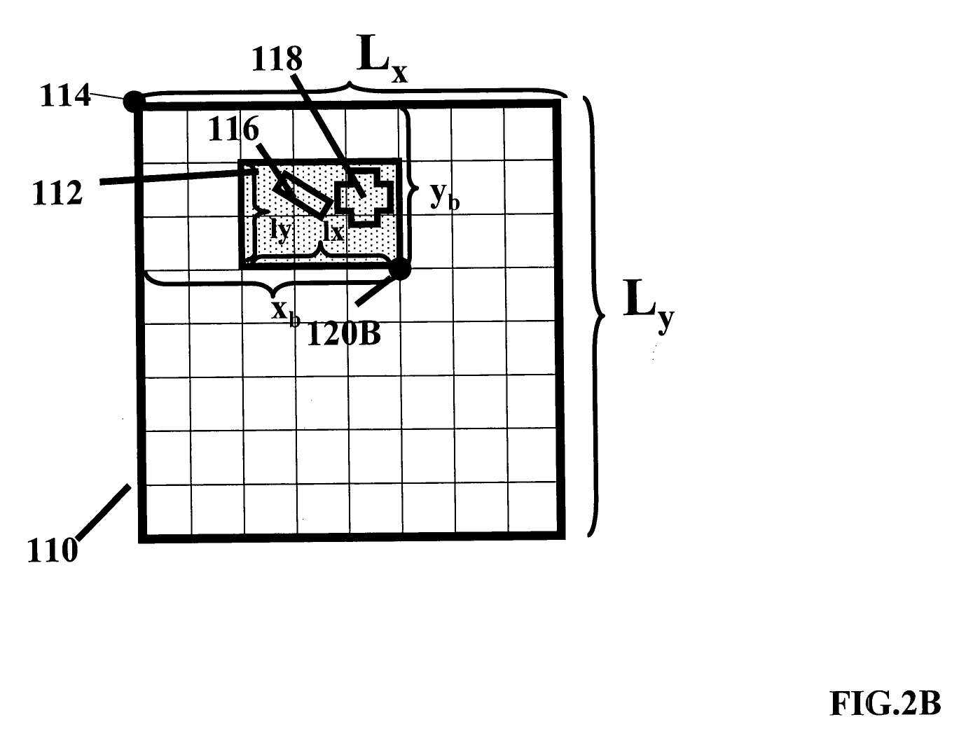

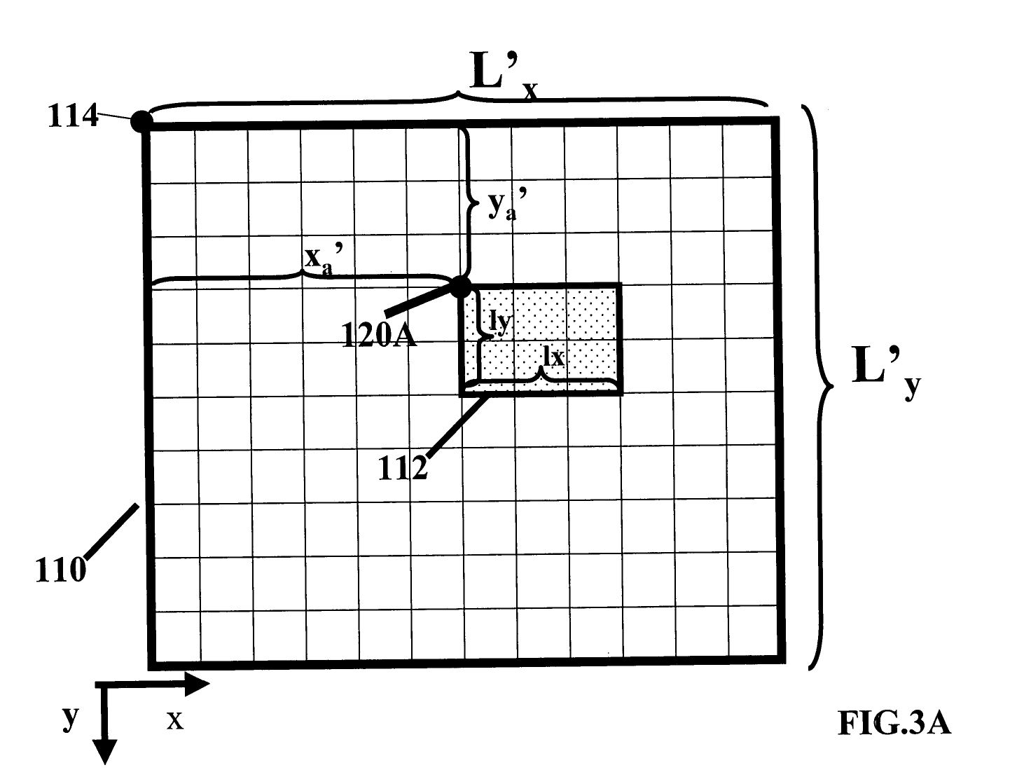

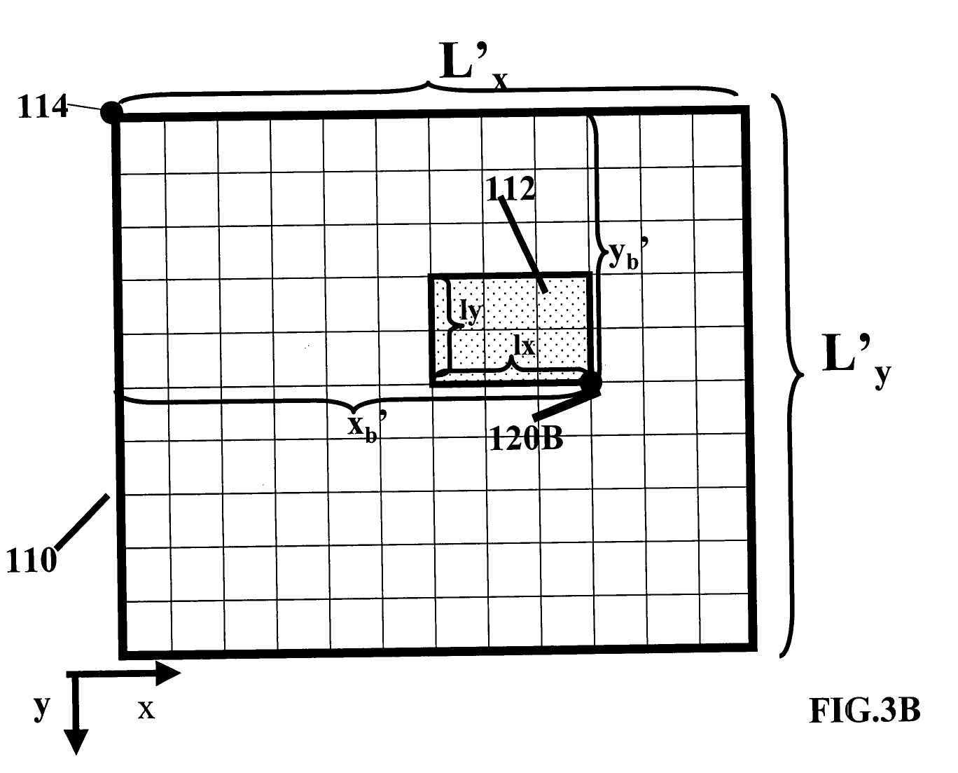

FIGS. 2-6 illustrate exemplary re-sizing transformations of an object 112 (e.g. an inner frame 112 referred to as a “placeholder”) situated within an outer frame (refereed to as an “ad”) 110. The original “reference ad” or “reference template” is provided in FIG. 2, while FIGS. 3-6 display the re-sized result when the dimensions of the outer frame 110 or ad are modified. The resizing is effected by changing the dimensions of the outer frame 110.

It is noted that the term “placeholder” is defined as a visible or invisible frame (e.g. including but not limited to a rectangular frame) within an outer frame containing graphical objects embedded therein. A placeholder, even an invisible placeholder directly or indirectly containing at least one visible graphical object, is also defined to be an example of a “graphical object” in addition to what are conventionally defined as graphical objects.

Both the placeholder 112 and the outer frame 110 are each associated with a locator or “reference” point. Generally, the reference point of the outer frame 110 is arbitrarily chosen to be the upper left hand corner 114, as is shown in FIGS. 2-6, thought it is appreciated that any point fixed relative to the outer frame 110 is appropriate. Optionally, a user interface is provided for explicitly selecting the reference point of any outer frame 110.

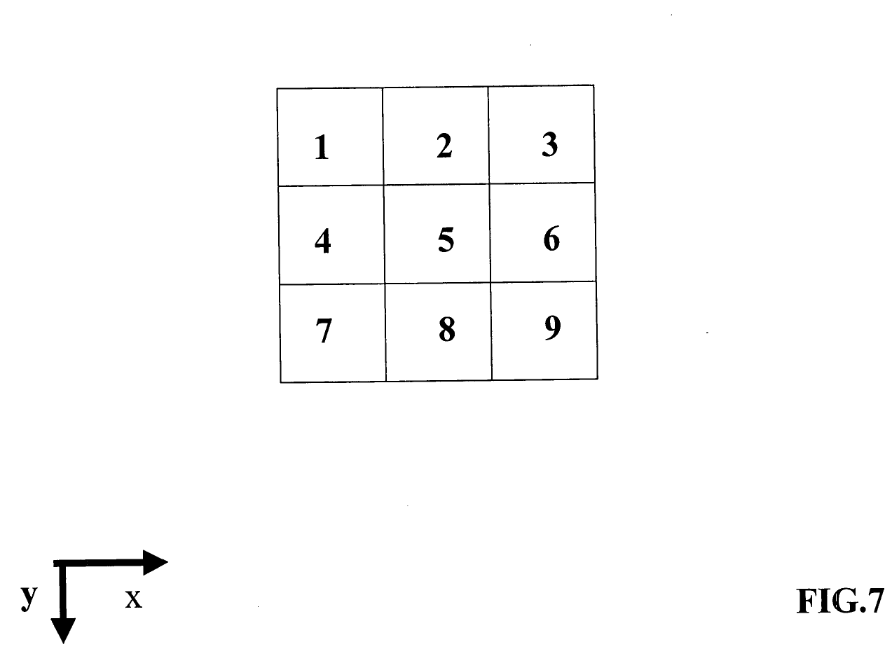

As shown in FIG. 2A, the reference point 120A of the placeholder 110 is also the upper left hand corner. In contrast, in FIG. 2B, the reference point 120A of the placeholder 110 is the lower right hand corner. As will be shown below, reference points are used to determine the position of the placeholder 112 relative to the outer frame 110 after the dimensions of the outer frame are modified. According to the convention defined in FIG. 7, reference points 114 and 120A of FIG. 2A both have alignment values (or grid parameters) of “1” (upper left corner). In contrast, according to the convention defined in FIG. 7, reference point 120B FIGS. 2B, 3B, 4B and 5B have an alignment value of “9” (lower right corner).

Although it is appreciated that any reference point may be chosen for either the placeholder 112 and the outer frame 110, throughout this disclosure the upper left corner (e.g. alignment value of “1”) will always be selected for the outer frame 110. The specific reference point for the placeholder 112 will vary depending on what is selected, and selection of the particular reference point 112 is operative to select re-sizing properties of the placeholder 112.

In some embodiments, the reference point of the outer frame 110 and or the placeholder 112 may be selected through a user interface. Furthermore, although any location may appropriately be selected for the reference point of the placeholder 112, throughout this disclosure the reference point will be selected from the nine possible points disclosed in FIG. 7, and will be referred to as the “location of the reference point (e.g. such as a discrete location)” of the placeholder 112. Note that in some embodiments, the reference point may be selected through a user interface by choosing one of a plurality of pre-defined points, including but not limited to the “alignment points” of FIG. 7.

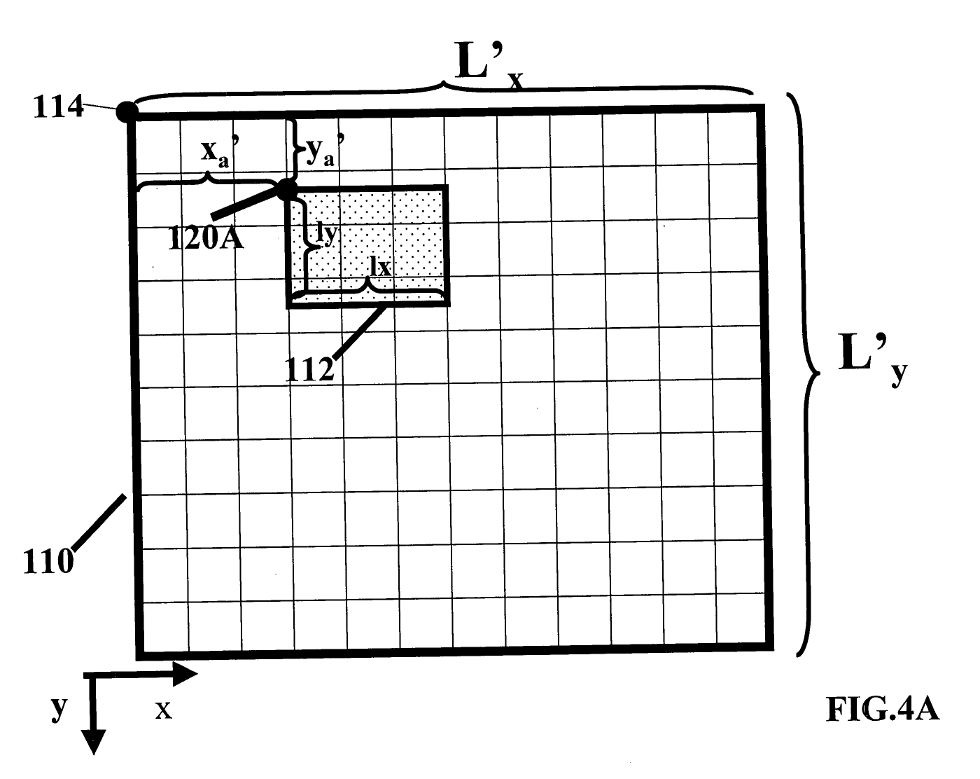

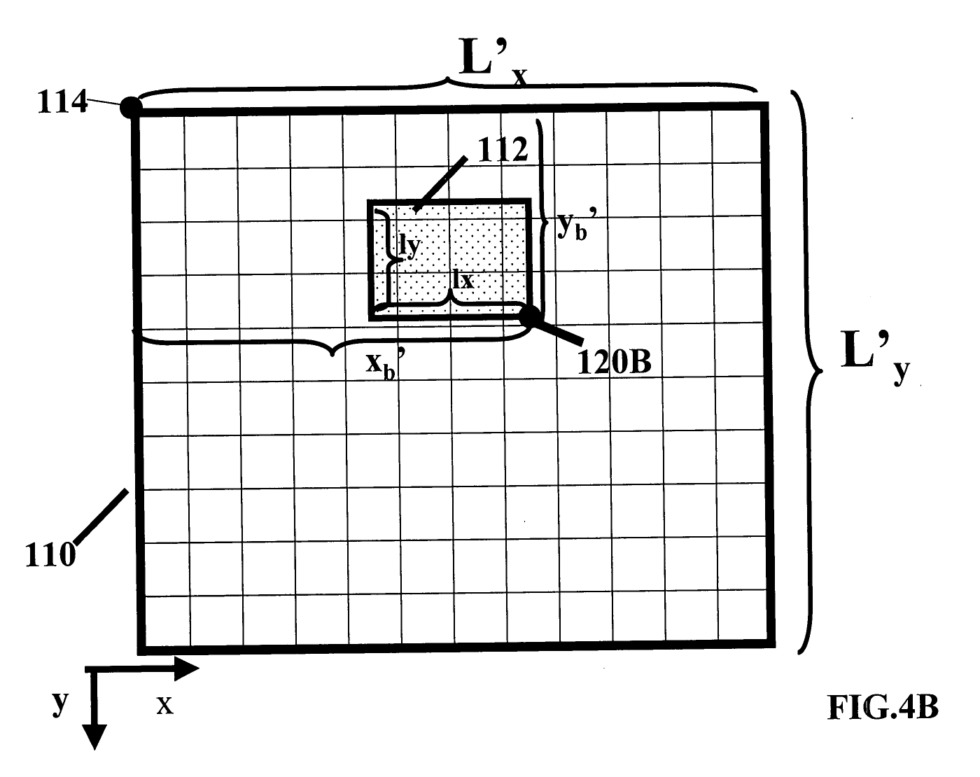

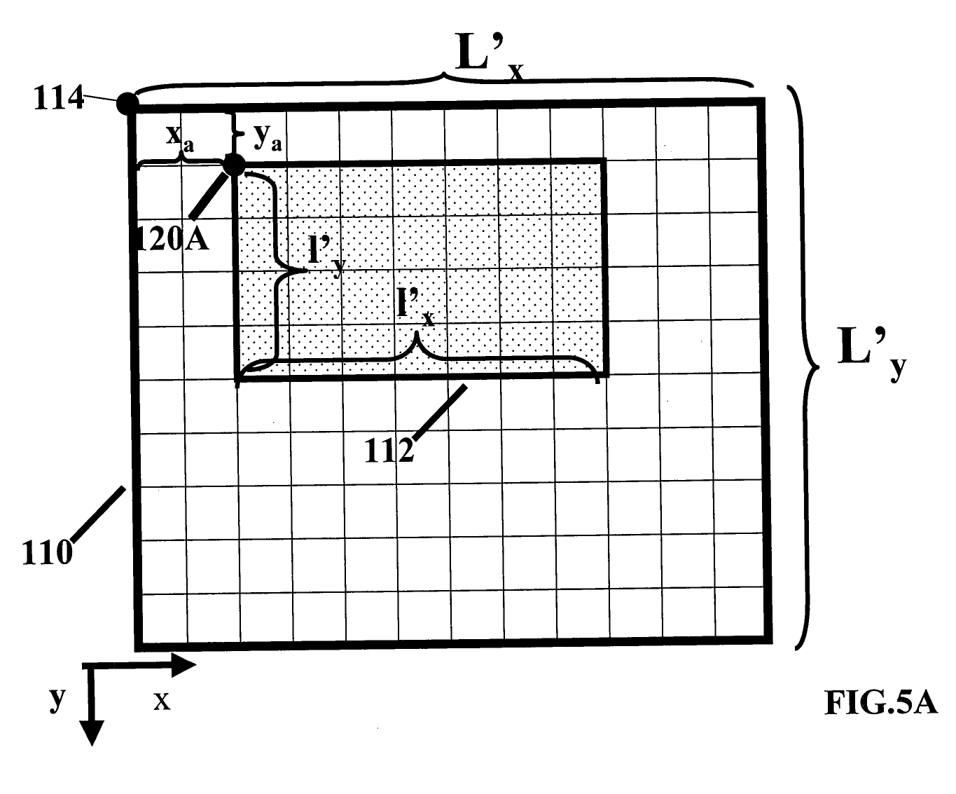

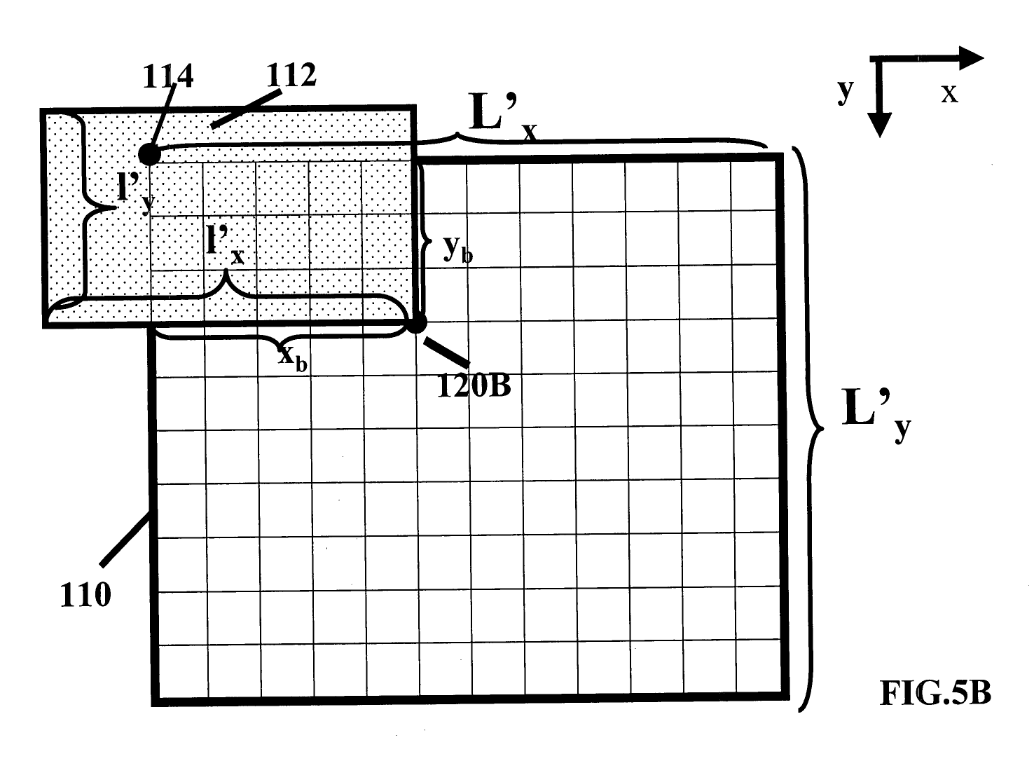

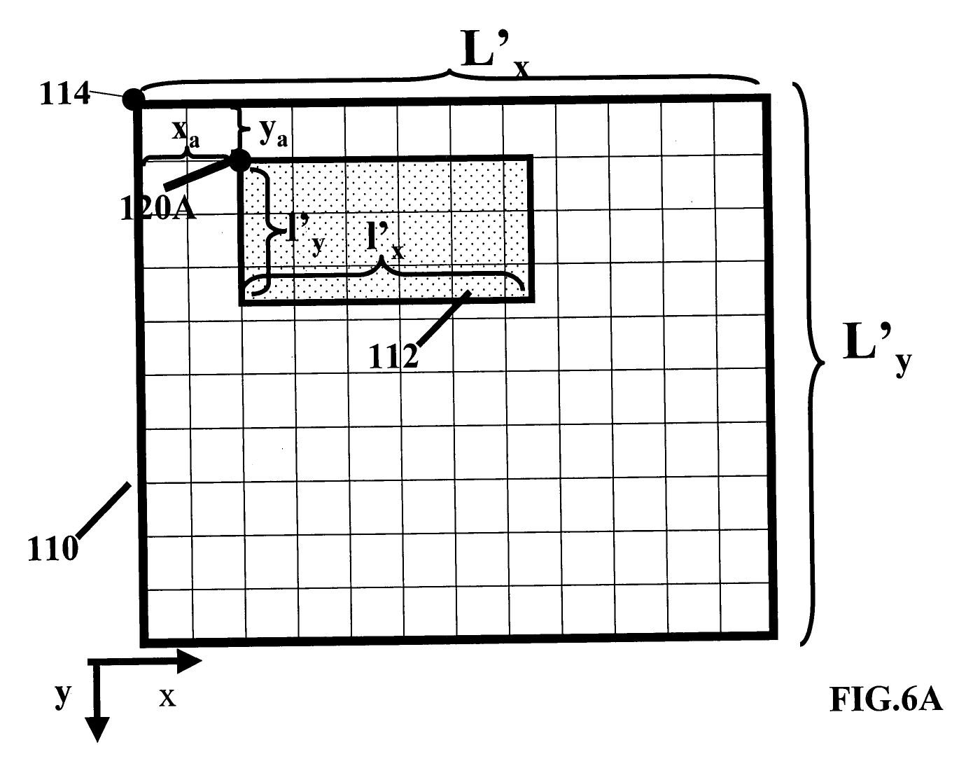

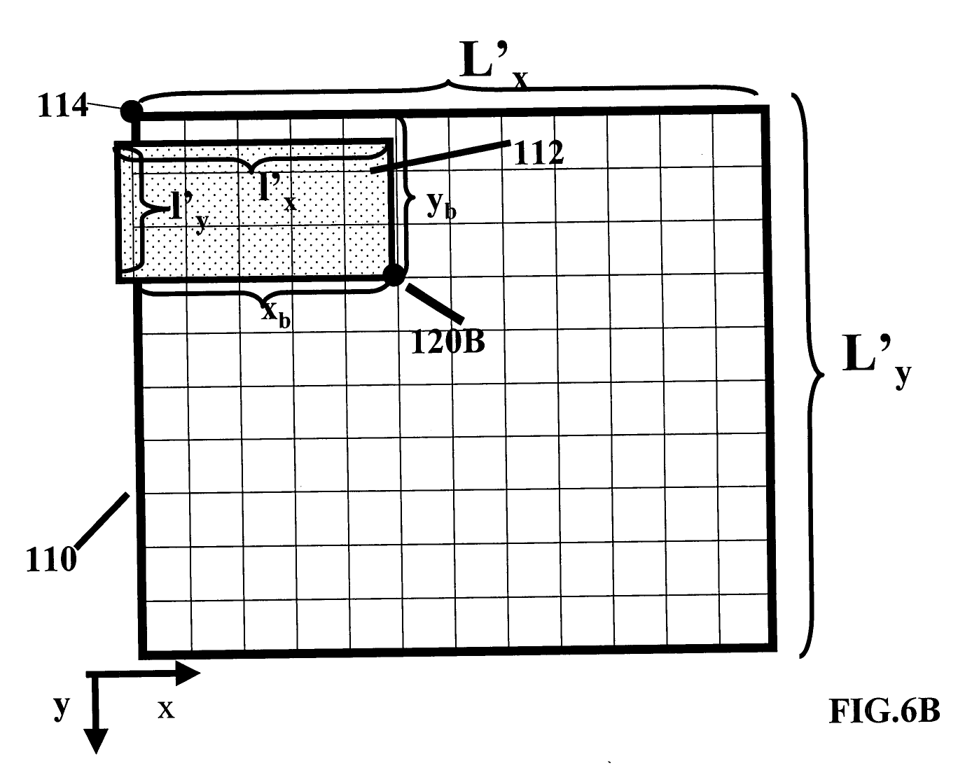

Generally, one or more internal graphical objects (for example, 118 or 116 as illustrated in FIG. 2A) are embedded within the placeholder 112 which may in itself serve as an outer frame 112 for the one or more embedded internal objects (e.g. including objects lacking any axes of symmetry). In the event that the placeholder 112 is scaled (e.g. at least one dimension of the placeholder 112 is modified, e.g. as in FIGS. 5-6 but NOT as in FIGS. 3-4), then the inner graphical (or text) objects 118 (or 116) within the placeholder are hierarchically re-sized (e.g. shifted, scaled, etc.) in accordance with the re-size parameter of each inner graphical object 118, and/or in accordance with “best fit” algorithms described below.

As used herein, an “internal graphical object” is a graphical object embedded within a placeholder that is embedded with an outer frame 110. The placeholder has “re-sizing parameters” defining how the placeholder is re-sized relative to the outer frame 110, while the internal graphical object optionally has “inner re-size parameters” or “internal re-size parameters” defining how the internal graphical object is re-sized within the placeholder.

In the event that the inner graphical object is itself a placeholder (e.g. “inner” placeholder 116), this inner placeholder 116 is re-sized (e.g. shifted and scaled) in accordance with the re-size parameters of the inner placeholder 116. Furthermore, it is noted that there may be inner graphical (or text) objects embedded within this inner placeholder 116. Thus, in the event that the inner placeholder 116 is scaled (e.g. the dimensions are modified), the inner placeholder 116 functions as an outer frame for re-sizing the graphical objects embedded within the inner placeholder 116. Thus, it may be said that one feature provided by some embodiments of the present invention is hierarchical resizing of objects embedded within re-sized placeholders, and hierarchical re-sizing of objects embedded within placeholders embedded within placeholders. This hierarchical re-sizing is performed in accordance with the re-sizing parameters.

Mathematical definitions of exemplary re-size parameters will now be given.

Definitions of Variables

Please note that Lx denotes the length of outer frame 110 in the x-dimension before the change in dimensions, and L′x denotes the length of outer frame 110 in the x-dimension after the change in dimensions. Please note that Ly denotes the length of outer frame 110 in the y-dimension before the change in dimensions, and L′y denotes the length of outer frame 110 in the y-dimension after the change in dimensions. Similar definitions exist in other dimensions.

Please note the lx is the length of the placeholder 112 (or in the event that there is no explicit placeholder 112, the length of the minimal containing rectangle) in the x dimension before re-scaling. In the event that re-scaling is performed in the x direction, then l′x is the length of the placeholder after re-scaling. Similar definitions exist in the y dimensions or other dimensions.

Please note that x is the position of a reference point 120 of a placeholder 112 (or in the event that there is no explicit placeholder 112, the position of a reference point 120 of the minimal containing rectangle) in the x dimension relative to an axis origin (a reference point of the outer frame 110, such as reference point 114) before a shift transformation. In the event that a shift transformation is performed in the x direction, then x′ is the position of the reference point of the placeholder 110 after re-scaling. Similar definitions exist in the y, z dimensions or other dimensions.

Definition of Re-Scalings and Shifts of Placeholders and/or Graphical Objects

In the examples of FIGS. 2-6, it is noted that FIG. 2 presents a “model” or the “original” layout before re-sizing. Thus, the outer frame 110 of FIGS. 2A-2B are referred to as the model frame before the outer frame re-sizing. The outer frame of FIGS. 3-6 are the “re-sized” outer frame 110 after one or more dimensions of the model outer frame have been modified.

In the examples of FIGS. 3-6, two specific re-size parameters will be discussed:

A) re-scaling of the placeholder 112 (e.g. FIGS. 5-6). It is noted that re-scaling does NOT influence the distance (e.g. the absolute distance) between the reference point 120 of the placeholder 112 and the reference point 114 of the outer frame 110 (the “ad”). Thus, in the event that the placeholder is ONLY scaled, there is no “shifting,” (e.g. the distance between the respective reference points necessarily remains fixed).

Two types of re-scaling are presented:
I) proportional or percentage re-scaling (FIG. 6) defined by the formula:
   l′ₓ/L′ₓ=lₓ/Lₓ; l′_{y}/L′_{y}=l_{y}/L_{y}
   (e.g. in a given dimension (e.g. x, y, z) the ratio between the length of the placeholder 112 or bounding rectangle and the length of the outer frame 110 is preserved after the length of the outer frame 110 is modified (e.g. increased or decreased))
II) delta re-scaling (FIG. 5) in the x and/or v direction according to a “delta” parameter in the x or y direction. The delta parameter is defined as the change in the characteristic length or width of the external frame 110.
   l′ₓ=lₓ+(L′ₓ−Lₓ)
   l′_{y}=l_{y}+(L′_{y}−L_{y})
   (e.g. in a given dimension (e.g. x, y, z), the length of the placeholder 112 or bounding rectangle after the length of the outer frame 110 is modified (e.g. increased or decreased) equals the length of the placeholder 112 or bounding rectangle before the length of the outer frame 110 is modified added to the increment (e.g. positive or negative) by which the length of the outer frame 110 is modified (e.g. increased or decreased))

B) shifting of the placeholder 112 (e.g. FIGS. 3-4).

Thus, it is noted that for some examples, the actual “size” of a “re-sized” shifted graphical element may not change (e.g. when there is no concomitant re-scaling), yet for the purposes of this disclosure, “re-sizing” also includes shifting locations of graphical elements that retain their size in at least one dimension.

Two types of placeholder 112 shift are presented, and illustrated by the examples of FIGS. 3-4:
I) proportional or percentage shift (FIG. 4);
   x′/L′ₓ=x/Lₓ; y′/L′_{y}=y/L_{y}
   (e.g. in a given dimension (e.g. x, y, z) the ratio between the position of a locator or reference point of the placeholder 112 or bounding rectangle and the length of the outer frame 110 is preserved after the length of the outer frame 110 is modified (e.g. increased or decreased)). We note that for proportional or percent shift, in some embodiments, the amount of shift may be sensitive to which reference point of the placeholder 112 or graphical object is selected.
II) delta shift (FIG. 3) in the x and/or y direction, according to a “delta” parameter in the x or y direction. The delta parameter is defined as the change in the characteristic length or width of the external frame 110.
   x′=x=(L′ₓ−Lₓ)
   y′−y=(L′_{y}−L_{y})
   (e.g. in a given dimension (e.g. x, y, z), the position relative to a fixed origin of a point of the placeholder 112 or graphical object shifts by a value equal to the increment (e.g. positive or negative) by which the length of the outer frame 110 is modified (e.g. increased or decreased)). We note that for delta shift, in some embodiments, the amount of shift is insensitive to which reference point of the placeholder 112 or graphical object is selected.

For the examples illustrated in FIGS. 2-6, both the object 112 (e.g. placeholder) which is re-sized (e.g. scaled and shifted) and the external outer frame 110 are rectangular, though it is appreciated that this is not a limitation of the present invention.

As shown in the example of FIG. 2, the outer frame 110 has a length (along the x axis) of 8 units and a width of 8 units (along the y axis). In the examples of FIGS. 3-6, the dimensions of the outer frame 110 are modified so that the length (along the x axis) becomes 12 units (e.g. producing a “x delta” of 12−8=+4 units) and the width (along the y axis) becomes 10 units (e.g. producing a “y delta” of 10−8=+2 units). Thus, for the examples of FIGS. 3-6, the “x delta” parameter is equal to +4 units, and the “y delta” parameter is equal to +2 units.

FIG. 3A illustrates a “delta shift only, location of the reference point (e.g. such as a discrete location) of the placeholder is ‘1’ (e.g. upper left corner), no scale” re-sizing of the placeholder 112 associated with outer frame 110. Thus, the placeholder 112 is shifted so that the x component of the distance between the reference point 120A of the placeholder 112 and the reference point 114 of the outer frame 110 increases by the “x delta” parameter (e.g. 4 units), while the y component of the distance between the reference point 114 of the placeholder 112 and the reference point 114 of the outer frame 110 increases by the “y delta” parameter (e.g. 2 units).

FIG. 3B illustrates a “delta shift only, location of the reference point (e.g. such as a discrete location) of the placeholder is ‘9’ (e.g. lower right corner), no scale” re-sizing of the placeholder 112 associated with outer frame 110. Thus, the placeholder 112 is shifted so that the x component of the distance between the reference point 120B of the placeholder 112 and the reference point 114 of the outer frame 110 increases by the “x delta” parameter (e.g. 4 units), while the y component of the distance between the reference point 114 of the placeholder 112 and the reference point 114 of the outer frame 110 increases by the “y delta” parameter (e.g. 2 units). It is noted that for the specific case where only a delta shift is performed (e.g. no re-scaling), the specific location of the reference point 120B of the inner frame is immaterial, and indeed, the re-sizings or transformations of FIGS. 3A and 3B, which differ only by the location of the reference point (e.g. such as a discrete location), produce the same location and size for the placeholder 112.

In both FIGS. 3A and 3B, the location of the placeholder 112 shifts to the right and down relative to the location in FIG. 2, due to the fact that the x and y dimensions of the outer frame 110 both increase. In the event of a decrease in dimensions, the placeholder 112 would shift up and/or to the left.

FIGS. 4A and 4B both illustrate a proportional or % shift only (e.g. no scale) of the placeholder 112, were in FIG. 4A the reference point 120 has a “1” position (e.g. top left) while in FIG. 4B the reference point 120 has a “9” position (e.g. bottom right). According to the % shift, the reference point 120 of the placeholder 112 maintains its “proportional position” in the re-sized outer frame 110 after the frame is re-sized, while the rest of the placeholder 112 is concomitantly shifted while maintaining the same orientation relative to the external frame 110.

Thus, in FIG. 2, the “proportional position” of the “1” position reference point (e.g. top left) of the placeholder 112 is ( 2/8,⅛)=(0.25,0.125). The “proportional position” of the “9” position reference point (e.g. bottom right) is (⅝,⅜)=(0.625,0.375).

Returning to FIGS. 4A and 4B, it is noted that the proportional position of each respective reference point is the same as in FIG. 2 (e.g. before re-sizing). Thus, in FIG. 4A, the absolute position of the reference point 120A of the placeholder 112 is (0.25*12,0.125*10)=(3,1.25). Thus, in FIG. 4B, the absolute position of the reference point 120 of the placeholder 112 is (0.625*12,0.275*10)=(7.5,3.75).

While FIGS. 3-4 refer to shifting the placeholder 112 after re-sizing the outer frame 110, FIGS. 5-6 refer to re-scaling the placeholder 112 after re-sizing the outer frame 110. In particular, FIGS. 5A and 5B provide images of the “delta scaled” placeholder 112 for respective examples where the reference point has the “1” aignment position (e.g. top left) and the “9” position position (e.g. bottom right).

Because FIGS. 5-6 refer to re-scaling without any shift, the position of the reference point of the placeholder 112 remains fixed relative to the reference point of the outer frame 110 (e.g. the top left corer of the outer frame). In particular, FIG. 5 refers to delta re-scaling and FIG. 6 refers to % re-scaling. Thus, in FIG. 5A, the scaled placeholder 112 expands 4 units in the x direction (e.g. the “x delta parameter” described above) to the right (e.g. because the reference point 120A is on the left edge of the placeholder 112), and the scaled placeholder 112 expands 2 units in the y direction (e.g. the “y delta parameter” described above) down (e.g. because the reference point 120 is on the top edge of the placeholder 112).

In FIG. 5B, the scaled placeholder 112 expands 4 units in the x direction (e.g. the “x delta parameter” described above) to the left (e.g. because the reference point 120B is on the right edge of the placeholder 112), and the scaled placeholder 112 expands 2 units in the y direction (e.g. the “y delta parameter” described above) up (e.g. because the reference point 120 is on the bottom edge of the placeholder 112).

It is noted that the “ballooning” re-scaling of FIS. 5-6 (e.g. re-scaling where the dimensions are the object are defined by the equations above, but where other aspects are defined at least in part by the location of a reference point of the placeholder 112 or a reference point of any other object within the external frame 110 being scaled) is not a limitation of the present invention.

The examples of FIGS. 5A-5B relate to examples where the reference point 120 of the placeholder 112 is located in a corner—e.g. simultaneously on two edges. It is appreciated, for example, that where the reference point 120 is located in between two edges (e.g. for example, in the “8” position), then during a delta scaling (e.g. without a delta shift) the reference point 120 of the placeholder 112 remains fixed relative to the reference point 114 of the outer frame, and the placeholder 112 expands both to the left and to the right (or both up and down, for example, for “4” position).

Returning to the example of FIG. 5B, it is noted that the delta scale has caused the placeholder 112 to expand beyond the domain defined by external frame 110. Thus, the re-sizing of FIG. 5B, in some embodiments, defines an “illegal re-sizing.” In some embodiments, a mechanism for detecting illegal re-sizings, defined as where at least a portion of an embedded object (e.g. the placeholder 112) extends beyond the external frame 110) is provided.

FIGS. 6A-6B provide images of % re-scaling only (e.g. no shift). Thus, according to FIG. 6A, the reference point 120A remains absolutely fixed relative to the reference point 114 of the outer frame 110, while the rest of the placeholder 112 is scaled down and to the right. According to FIG. 6B, the reference point 120B remains absolutely fixed relative to the reference point 114 of the outer frame 110, while the rest of the placeholder 112 is scaled up and to the left.

For the examples of FIGS. 2-6, the dimensions of the outer frame 110 are increased, and thus the examples of FIGS. 2-6 relate to “re-size up.” It is appreciated that in some embodiments of the present invention one or more dimensions of the model ad or model outer frame 110 exceed the respective dimensions of the re-sized outer frame 110 or ad, and thus it is noted that some embodiments of present invention relate to “re-size down.” Nevertheless, certain embodiments of the invention only provide for re-sizing up to simplify the software application.

It is noted that for the exemplary re-sizings (e.g. shifts and re-scalings) of FIGS. 3-6, the re-sizing of the two-dimensional graphical element (e.g. the placeholder 112) is also performed in two dimensions (e.g. deltaXY re-scaling of FIG. 5 in both the X and Y dimensions, % XY rescaling of FIG. 6 in both the X and Y directions, deltaXY shift of FIG. 3 in both the X and Y directions, % XY shift of FIG. 4 in both the X and Y directions) though this is by no means a limitation of the present invention. In some examples (including examples presented below), both the X and Y dimensions of the outer frame 110 change while graphical objects associated with the frame (e.g. a placeholder such as placeholder 112) are re-sized (e.g. shifted or scaled) in only one dimension (e.g. in the X dimension or Y dimension only).

Thus, as used herein, deltaXY scale (or % XY scale) denotes re-scaling as presented in the example of FIG. 5. delta X (or % X scale) denotes re-scaling only in the X dimension wherein the size of the scaled object is insensitive to changes in the Y dimension of external frame.

Furthermore, it is noted that the examples presented herein are two dimension examples of re-sizing, though it is appreciated that the same re-sizing operations may be performed on three-dimensional graphical objects associated with a three-dimensional container (e.g. including but not limited to a bonding rectangular prism).

Furthermore, although the examples presented herein provide re-sizing parameters (e.g. deltaXY shift, delta XY scale, % X shift, etc) do not depend on the extent to which one or more dimensions of the external container (e.g. the external frame 110) are modified, this is not a limitation of the present invention. Thus, in one example, a certain object within a bounding external frame 110 is assigned the re-size parameter “deltaX scale” in the event that the X dimension of the external frame or container 110 changes by less than 250% (or, say, less than 12 cm), and % X in the event that the X dimensions changes by more than 250% (or, say, more than 12 cm). This principle is generalized to re-sizing parameters dependent on intervals or ranges.

In the aforementioned examples, and throughout this document, examples of re-sizing of static pictures are presented, though it is understood that the scope of the present invention includes re-sizing of video content. In one example, videos of store circulars including graphical element embedded in external frames and placeholders are presented in a retail outlet on a plurality of video screens. These video graphical elements are re-sized appropriately on each screen in accordance with the dimensions of each video screen.

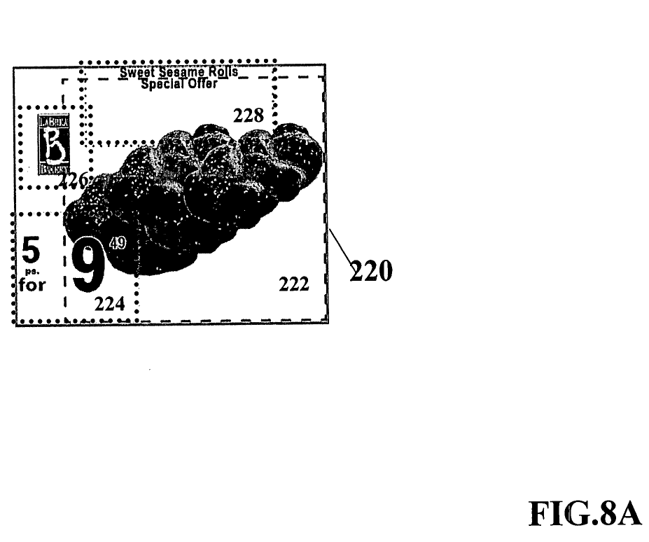

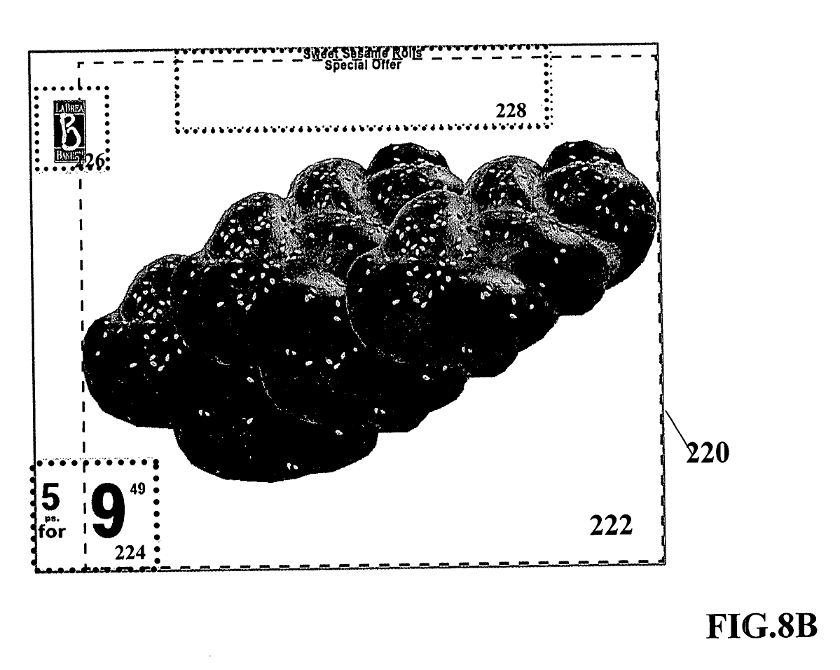

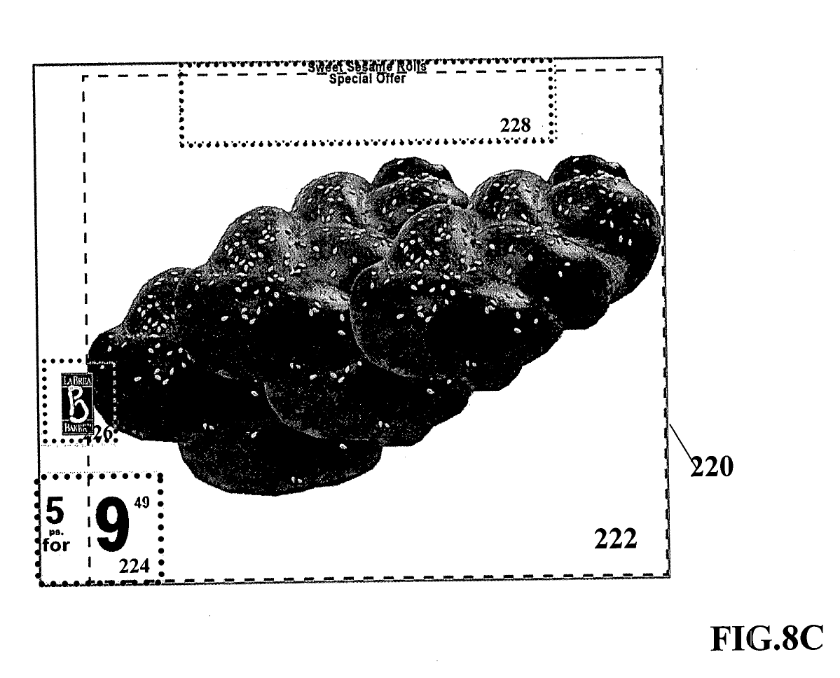

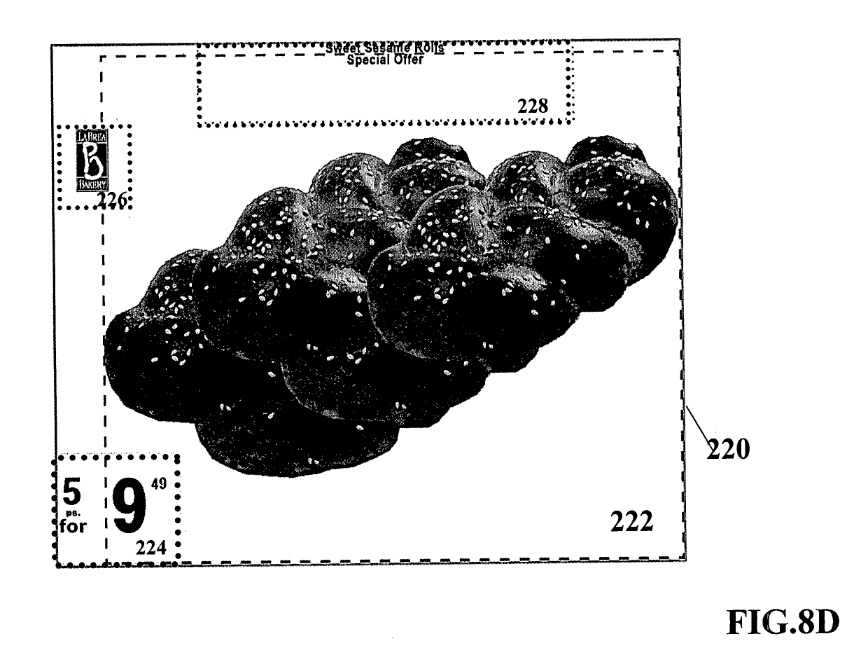

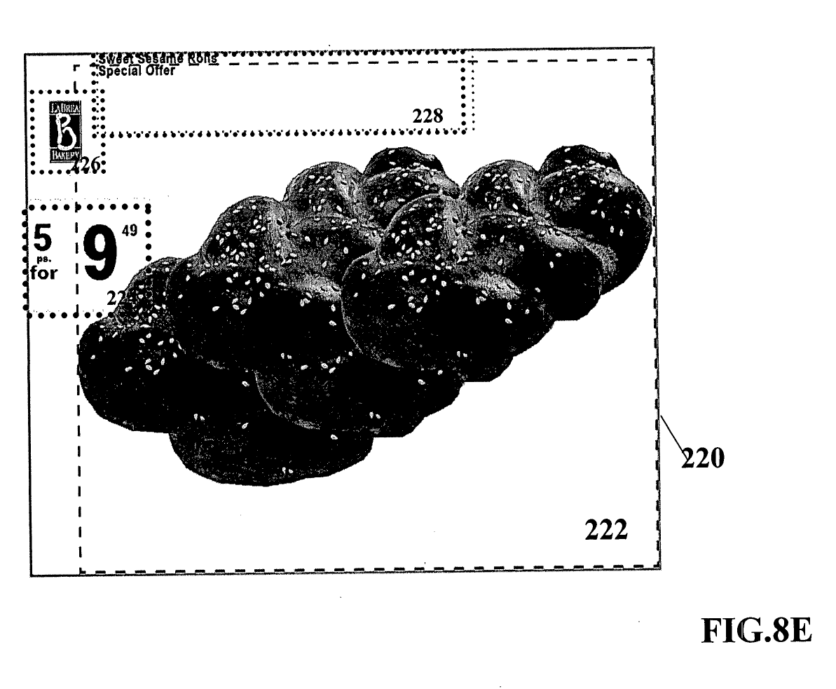

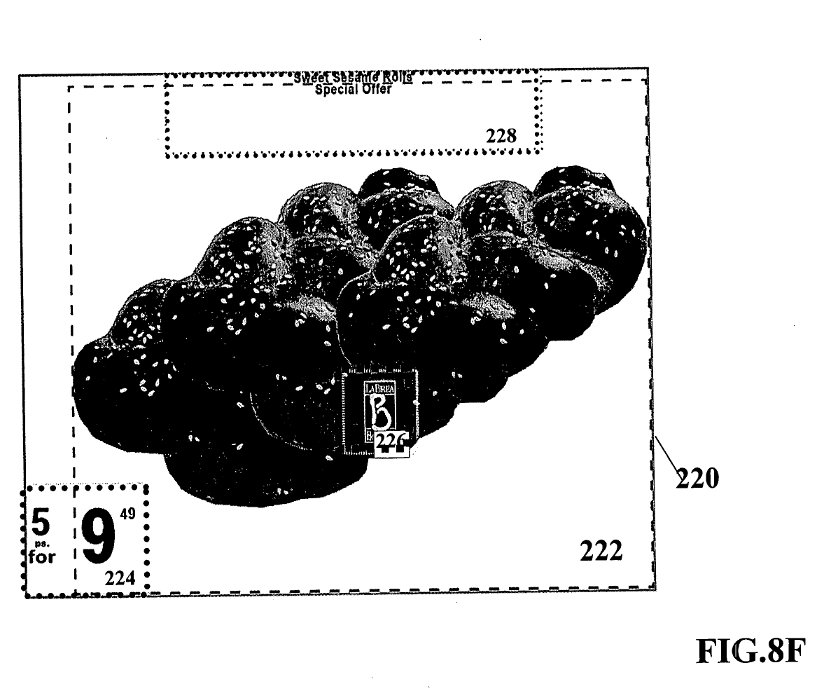

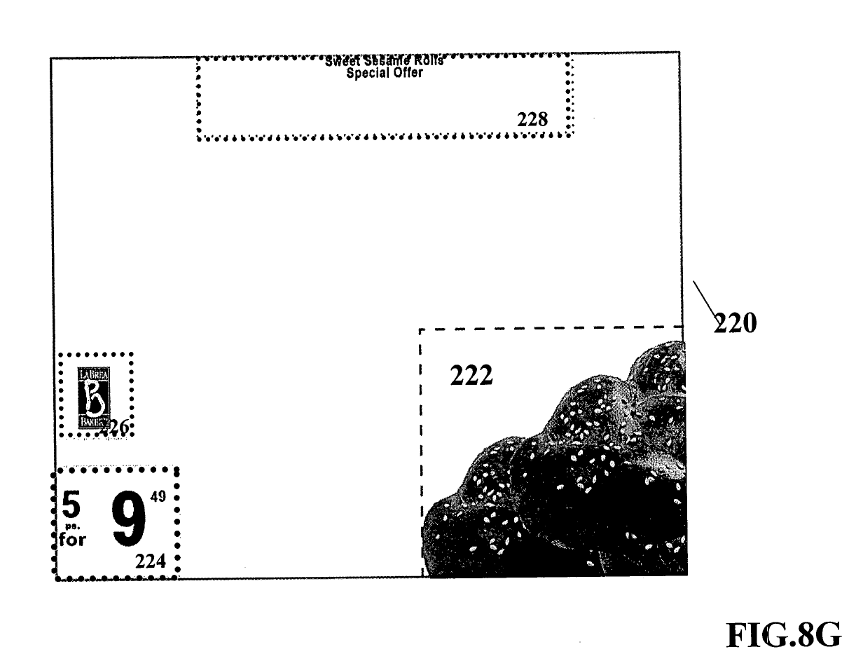

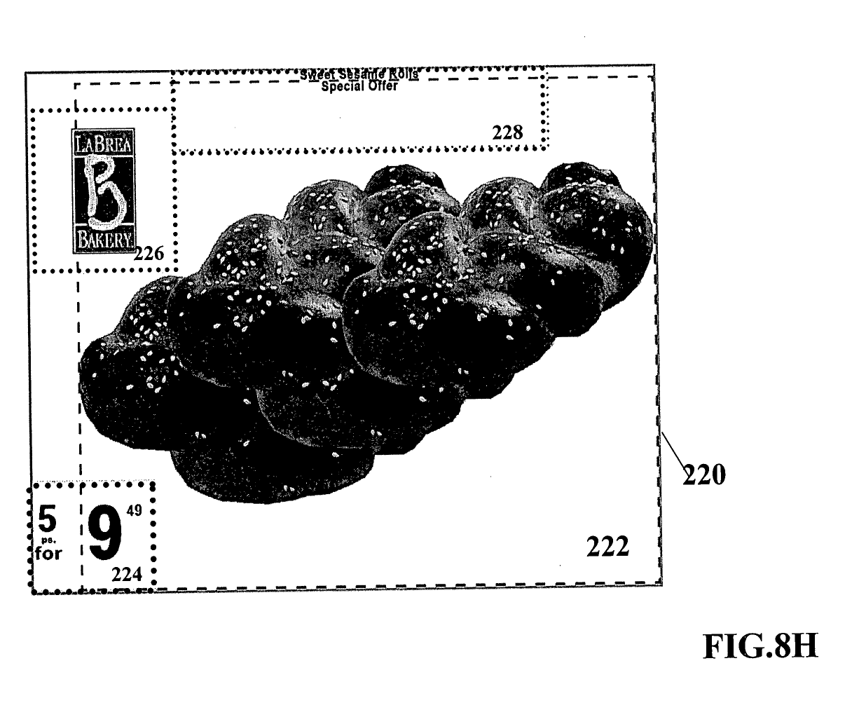

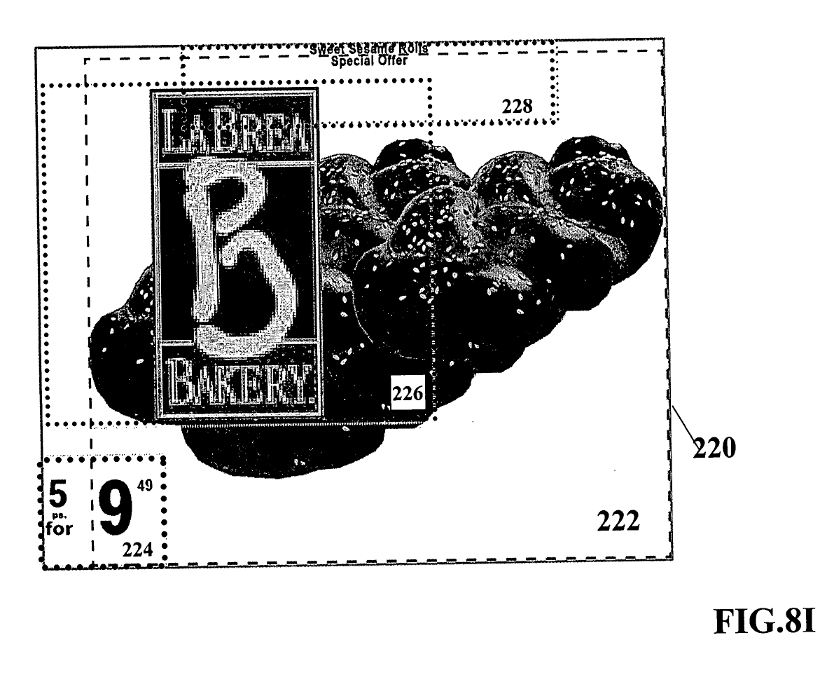

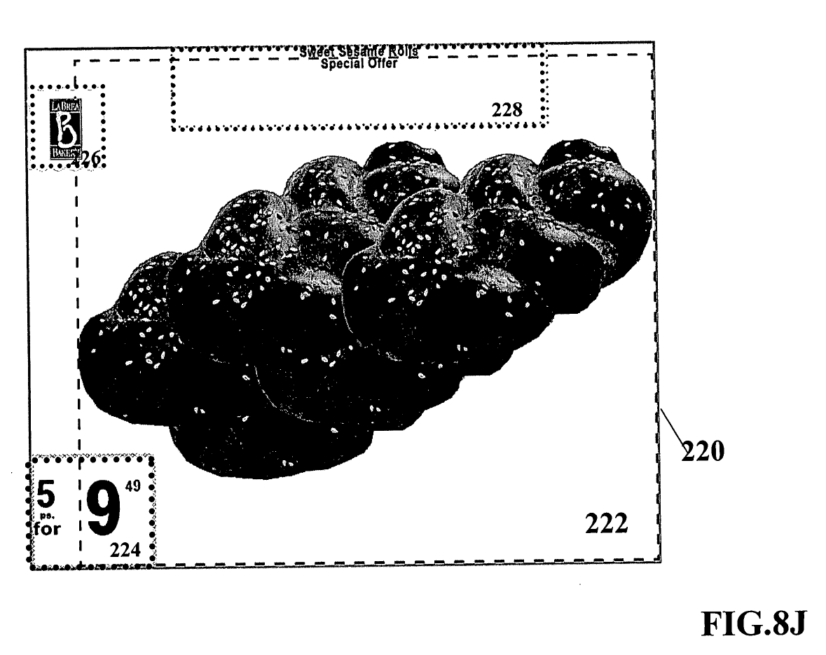

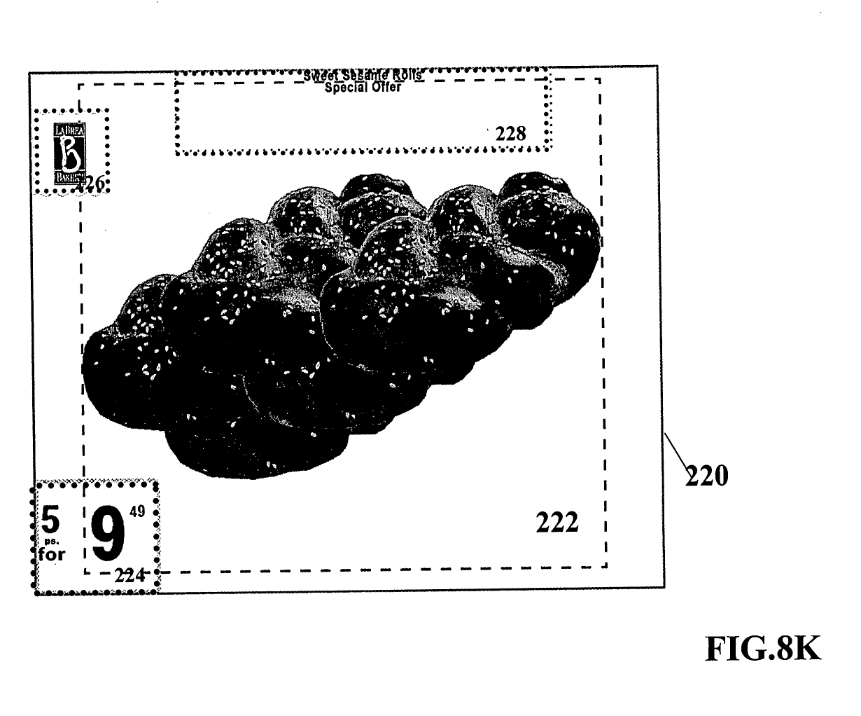

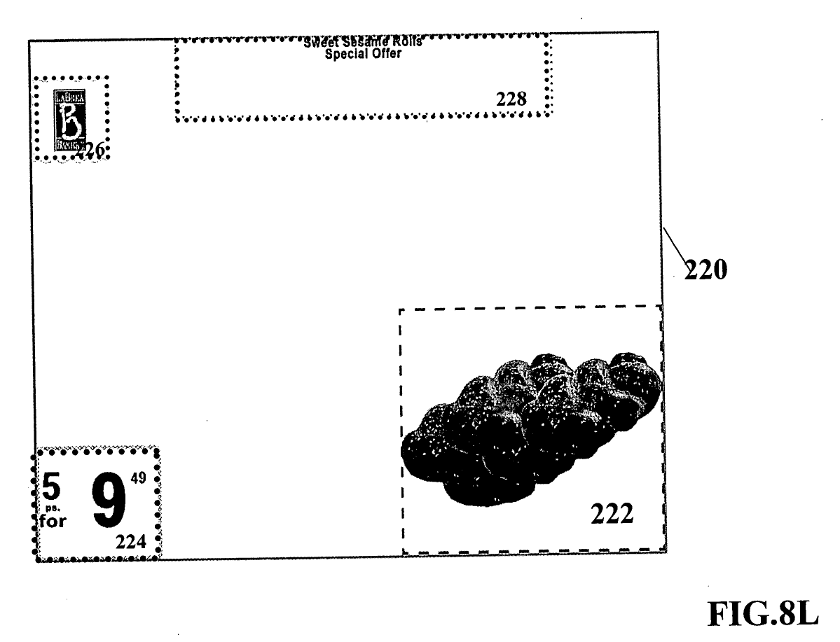

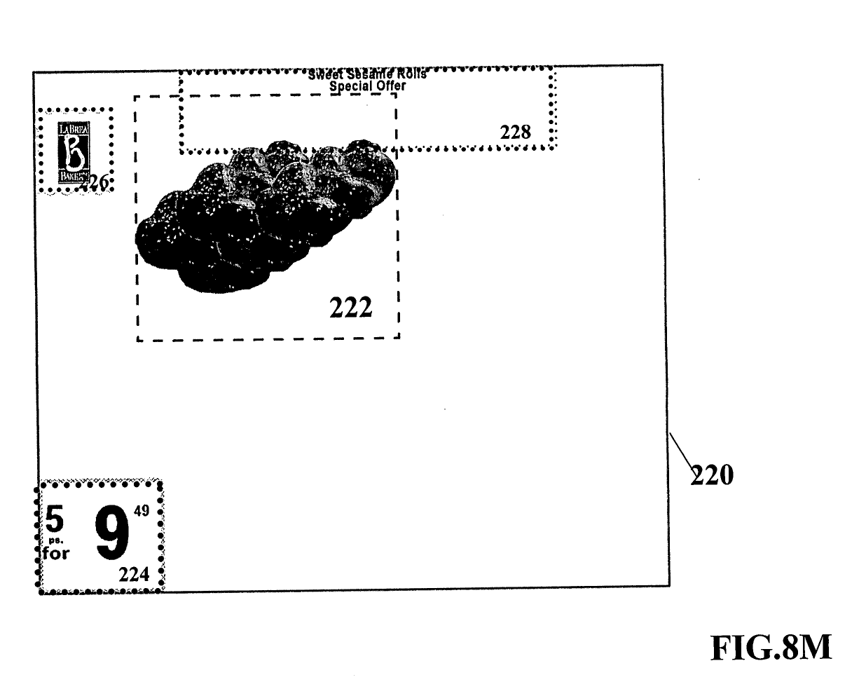

FIG. 8A refers to an exemplary advertisement 220 (e.g. a “model” ad or external frame 220 including associated re-sizable graphical elements) including a product image of kneaded sesame roll embedded in placeholder 222, labeling text embedded in placeholder 228, a “brand” labeling icon embedded in placeholder 226, and a graphical representation of product price information embedded in placeholder 224.

In FIGS. 8B-8M, the external frame 220 is re-sized and various placeholders within the external frame are shifted and scaled as described below. For the particular example of FIG. 8, the graphical objects are “directly” embedded within the various placeholders. Thus, graphical elements (as opposed to the text element “Sweet Sesame Rolls Spedcial Offer” embedded in placeholder 228) are scaled exactly as the placeholders are scaled. Furthermore, in general, the graphical and text elements are shifted relative to the external frame 220 as the placeholders are shifted, though in the example of FIG. 8, graphical and/or text objects may be subject to an additional optional shift-like “alignment transformation” within the placeholder, where a locator point (e.g. the center of the graphical and/or text element) is aligned to a pre-determined position within the placeholder, such as the positions defined in FIG. 7.

In FIGS. 8B-8M, the point (e.g. defined in FIG. 7) within the respective placeholder to which the graphical and/or text object is aligned within the placeholder is referred to as the “alignment” point of the graphical and/or text object. Furtheormore, throughout the example of FIG. 8, the reference point of the external frame 220 is defined as the top left corner of the frame (e.g. alignment “1”). The “reference point” of each particular placeholder within the external frame 220 is defined according to the convention of FIG. 7.

It is appreciated that in some examples that are different from those of FIG. 8, the graphical objects within the placeholders may shift are scaled differently than the scaling of the containing placeholders (e.g. 222, 224, 226 and 228)—for example, due to the graphical objects' being embedded within an “inner placeholder” within the respective placeholder, or due to a “best fit” routine. Thus, it is noted that the various textual and graphical objects (e.g. image, text, price and logo) of FIG. 8 are each “directly” embedded within the respective placeholder, and not within an “inner” placeholder. Furthermore, the “best fit” routine is not invoked in FIG. 8.

The tables below contain data specifying the re-sizings defined in FIG. 8. In specifically, re-size parameters in the tables provide data to define how each graphical or textual object within the external frame 220 is shifted or scaled when the dimensions of the external frame 220 are modified (e.g. from those of the “model” in FIG. 8A to the re-sized dimensions in FIGS. 8B-8M.

Resize Parameters for FIG. 8:

8B:

| | Image 222 | Text 228 | Price 224 | Logo 226 |
|---|---|---|---|---|
| Scale | D_XY | %_X | None | None |
| Shift | D_XY | %_X | D_Y | None |
| Reference point | 9 | 1 | N/A | N/A |
| Alignment point | 5 | 2 | 4 | 5 |

Discussion:
By choosing both the Scale XY and Shift XY for the placeholder of Image 222, the bottom right corner of the Image Placeholder shifts with the bottom right corner of the outer frame 220. The %_X (proportional shift in the X direction) maintains the text placeholder substantially centered in the X dimension. Note that the text placeholder 228 is scaled but the text maintains it size. In some embodiments of the present invention, the default behavior of objects (e.g. graphical and/or text objects) embedded within a placeholder and without explicit inner re-size parameters is to not scale the object whatsoever, though this is not a limitation. Typically, for text object this default behavior is operative. Another possible “default” behavior for objects (e.g. graphical and/or text objects) embedded within a placeholder without explicit inner re-size parameters is for % scale in all re-sized directions.
With regards to the price 224, the D_Y shift is operative to maintain the price in at the bottom of the enclosing frame.

It is noted that the logo placeholder, which is near the upper left corner of the original model FIG. 8A but not exactly located in the corner, does not move or re-size at all in absolute terms—this is effective because the logo object is a labeling object and not the advertised product, and thus, in the example of 8B, there is no real need to enlarge the logo object.

8C:

| | Image 222 | Text 228 | Price 224 | Logo 226 |
|---|---|---|---|---|
| Scale | D_XY | %_X | None | None |
| Shift | D_XY | %_X | D_Y | D_Y |
| Reference point | 9 | 1 | N/A | N/A |
| Alignment point | 5 | 2 | 4 | 5 |

Discussion:

Sometimes a user (e.g. graphical artist) prefers to associate the logo in placeholder 226 of the brand with the price. By choosing a delta_Y this brings the logo close to the bottom left corner near the price, and because in the model ad there was no overlap between the logo placeholder and the price placeholder, there is no overlap in the re-sized ad. More specifically, because both implement a D_Y (or DELTA_Y) re-size, the distance between the logo placeholder 226 and the Price 224 placeholder is preserved.

8D:

| | Image 222 | Text 228 | Price 224 | Logo 226 |
|---|---|---|---|---|
| Scale | D_XY | %_X | None | None |
| Shift | D_XY | %_X | D_Y | %_Y |
| Reference point | 9 | 1 | N/A | N/A |
| Alignment point | 5 | 2 | 4 | 5 |

Discussion:

It is noted that in the original model ad, the logo placeholder is substantially in the top left corner. This quality is preserved by using a %_Y re-size, and thus the affect of drawing the logo close to the price (e.g. FIG. 8C) is not achieved.

8E:

| | Image 222 | Text 228 | Price 224 | Logo 226 |
|---|---|---|---|---|
| Scale | D_XY | %_X | None | None |
| Shift | D_XY | None | None | None |
| Reference point | 9 | 1 | N/A | N/A |
| Alignment point | 5 | 1 | 4 | 5 |

Discussion:
By using the “none” re-size parameter in the X direction for the Price Placeholder 224, the absolute distance between the upper left corner and the price placeholder 224 remains preserved. This is also the case for the logo placeholder 226. Thus, logo and price objects give the appearance of moving to the upper left corner without clashing, thereby providing another method of drawing the logo and price closer.

Similary, the text is aligned in alignment point (grid parameter) 1 (top left), drawing the text closer to the logo. Thus, the effect created is to have the bread image (e.g. in placeholder 222) on one side of the frame (e.g. the right side), and to have all labeling object (e.g. the text, the logo, and the price) and the other side (e.g. the left side).

8F:

| | Image 222 | Text 228 | Price 224 | Logo 226 |
|---|---|---|---|---|
| Scale | D_XY | %_X | None | None |
| Shift | D_XY | %_X | D_Y | D_XY |
| Reference point | 9 | 1 | N/A | N/A |
| Alignment point | 5 | 2 | 4 | 5 |

Discussion:

By using D_XY re-size parameter for the logo 226, the logo drifts to the center/center bottom/center righjt of the bounding frame, which is effective for providing a label on the image itself. It is noted tghat used of %_XY instead of D_XY would have had a much lesser impact (e.g. less shifting down and to the right, less increase in size).

8G:

| | Image 222 | Text 228 | Price 224 | Logo 226 |
|---|---|---|---|---|
| Scale | D_XY | %_X | None | None |
| Shift | D_XY | %_X | D_Y | D_Y |
| Reference point | 1 | 1 | N/A | N/A |
| Alignment point | 5 | 2 | 4 | 5 |

Discussion:

The is an example of an invalid or illegal re-size parameter due to wrong choise of reference point of the image placeholder 222 (e.g. choosing 5).

8H:

| | Image 222 | Text 228 | Price 224 | Logo 226 |
|---|---|---|---|---|
| Scale | D_XY | %_X | None | %_XY |
| Shift | D_XY | %_X | D_Y | None |
| Reference point | 9 | 1 | N/A | 1 |
| Alignment point | 5 | 2 | 4 | 5 |

Discussion:

The logo is increased in size and the position maintained in the upper left corner.

8I:

| | Image 222 | Text 228 | Price 224 | Logo 226 |
|---|---|---|---|---|
| Scale | D_XY | %_X | None | D_XY |
| Shift | D_XY | %_X | D_Y | None |
| Reference point | 9 | 1 | N/A | 1 |
| Alignment point | 5 | 2 | 4 | 5 |

Discussion:

Use of delta re-size parameters to scale the logo creates an even larger logo than in FIG. 8H. In general, the parameters of FIG. 8H would be preferred in many applications.

8J:

| | Image 222 | Text 228 | Price 224 | Logo 226 |
|---|---|---|---|---|
| Scale | D_XY | %_X | None | None |
| Shift | None | %_X | D_Y | None |
| Reference point | 1 | 1 | N/A | N/A |
| Alignment point | 5 | 2 | 4 | 5 |

8K:

| | Image 222 | Text 228 | Price 224 | Logo 226 |
|---|---|---|---|---|
| Scale | %_XY | %_X | None | None |
| Shift | None | %_X | D_Y | None |
| Reference point | 1 | 1 | N/A | N/A |
| Alignment point | 5 | 2 | 4 | 5 |

Discussion:

In this example, a %_XY scale is chosen for the Image placeholder 222 rather than the delta D_XY scale of earlier examples. Furthermore, the shift parameter is “NONE”, thereby preserving the distance between the upper left corner (e.g. reference point 1) of the image placeholder 222 and the upper left corner of the bounding frame 220. Use of %_XY increases the size of the image placeholder 222 less than use of a D_XY would have increased the placeholder. Thus, in many applications, it is preferred to use D_XY scaling for the image placeholder 222 as described earlier.

8L:

| | Image 222 | Text 228 | Price 224 | Logo 226 |
|---|---|---|---|---|
| Scale | None | %_X | None | None |
| Shift | D_XY | %_X | D_Y | None |
| Reference point | N/A | 1 | N/A | N/A |
| Alignment point | 5 | 2 | 4 | 5 |

Discussion:

8M:

| | Image 222 | Text 228 | Price 224 | Logo 226 |
|---|---|---|---|---|
| Scale | None | %_X | None | None |
| Shift | %_XY | %_X | D_Y | None |
| Reference point | N/A | 1 | N/A | N/A |
| Alignment point | 5 | 2 | 4 | 5 |

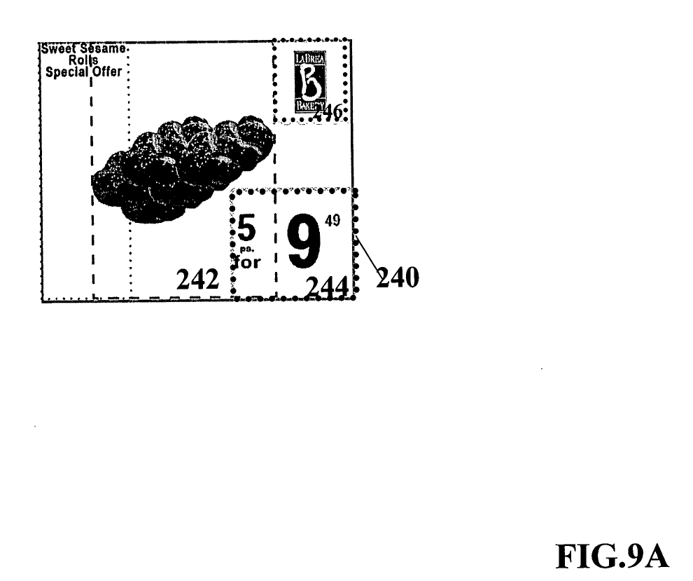

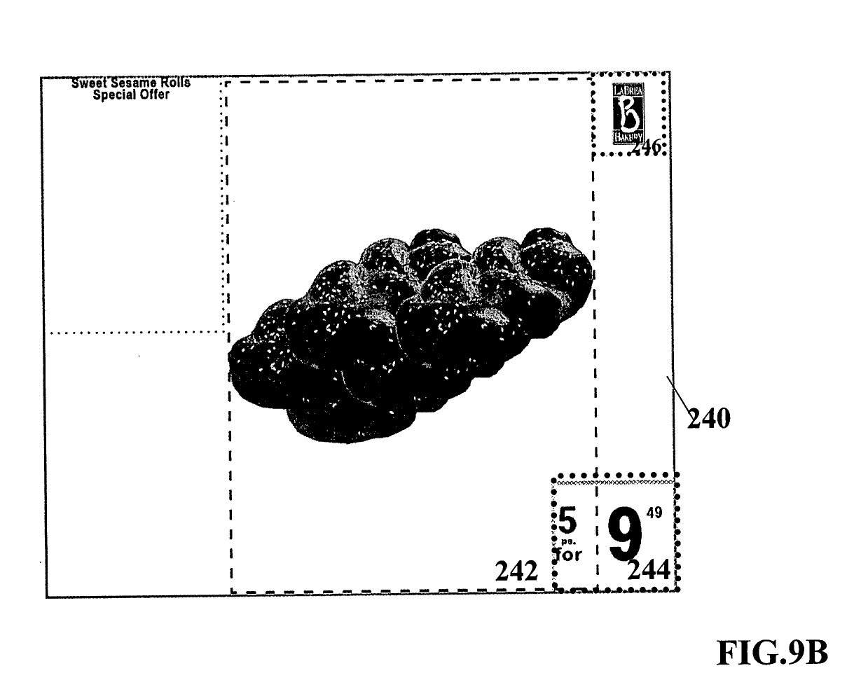

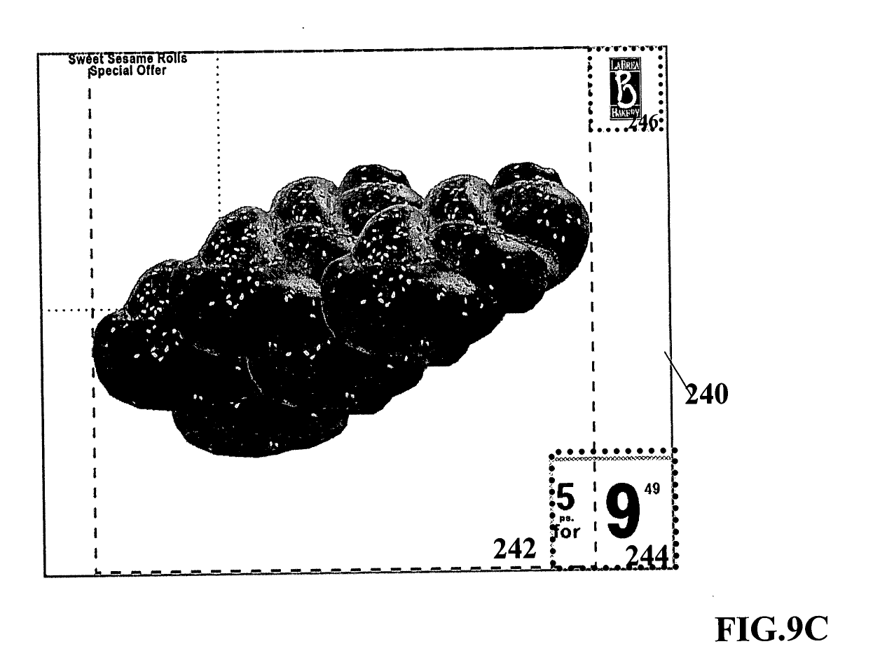

Examples of FIG. 9

FIG. 9A is a model template including a model bounding frame 240.

9B

| | Image 242 | Text 228 | Price 224 | Logo 246 |
|---|---|---|---|---|
| Scale | %_XY | % X | None | None |
| Shift | D_XY | % X | D_XY | D_X |
| Reference point | 9 | 1 | | |
| Alignment point | 7 | 2 | 6 | 5 |

9C

| | Image242 | Text 228 | Price 224 | Logo 246 |
|---|---|---|---|---|
| Scale | D_XY | % X | None | None |
| Shift | D_XY | % X | D_XY | D_X |
| Reference point | 9 | 1 | | |
| Alignment point | 7 | 2 | 6 | 5 |

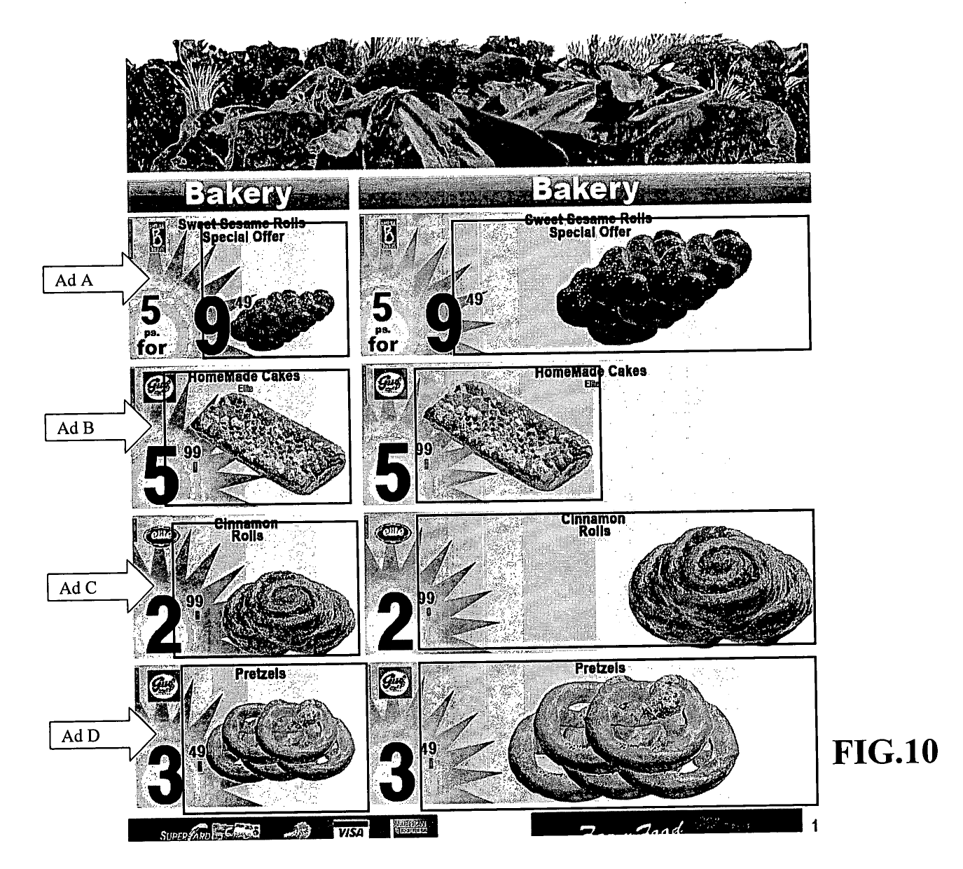

Discussion of 9B vs. 9C:
In 9B, the scaling is proportional, and 9C the scaling is delta, and thus 9C has the effect of enlarging the image placeholder 242 (and in this case this embedded image) to a greater extent.
Discussion of FIG. 10

It is noted that in this example, in many commercial applications, Ad A and Ad D achieve the desired “look and feel” preserving effect.

Ad A—the re-size values of image placeholder (kneaded bread) is Scale D_XY, Shift None. This is effective to allow the image to grow to the right while maintaining a fixed spatial relation with the left edge of the add.

Ad B—the re-size values of the image placeholder (e.g. cake) is “Scale None”, “Shift None”—thus the ad grows to the right while the image maintains its size and spatial relation to the left side of the ad.

Ad C—the re-size parameters are “shift none” and D_XY scale (which increases the size of the image). Choosing an alignment parameter of 9 shifts the image to the far right side of the ad frame.

Ad D—re-size parameters are like A. It is noted that because of the aspect ratio of the prezels (e.g. much wider in the X direction than the height in the Y direction) increases—this produces a pleasing effect because the aspect ratio was greater than one in the model image on the right side.

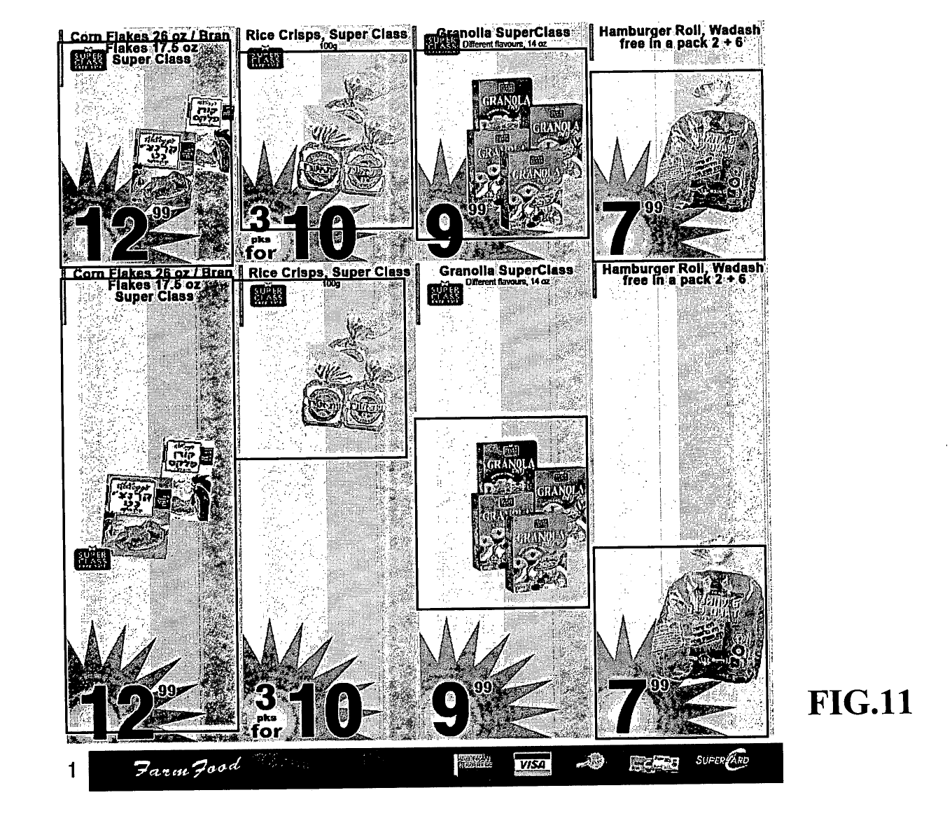

FIG. 11 describes re-sizing according to some embodiments of the present invention.

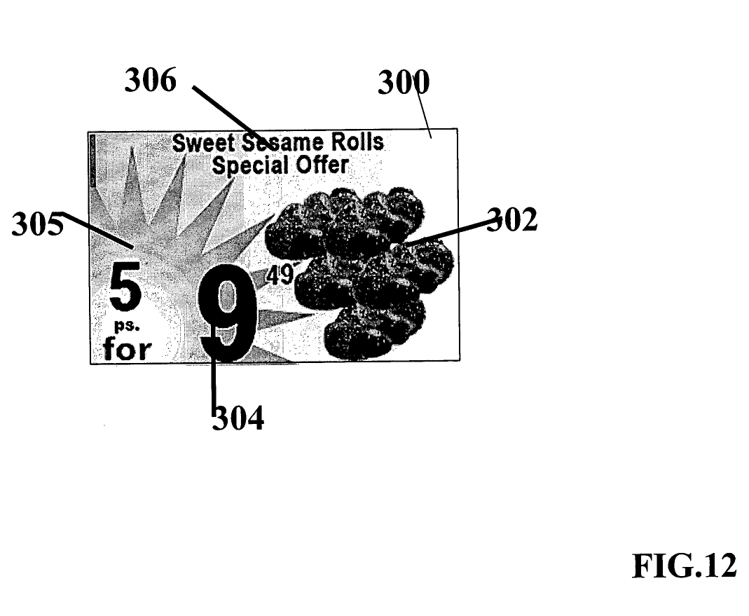

In some embodiments, a “best fitting algorithm” is used to place a target graphical object (e.g. the rolls 302 of FIG. 12) within a containing frame (e.g. 300 of FIG. 12) including a placeholder or an outer or external frame.

It is now disclosed for the first time a “best fitting” algorithm for sizing, shifting and/or optionally orienting a graphical object within a bounding frame. According to some embodiments, for each putative configuration (e.g. position, orientation, scaling/size) of the target object is given a score.

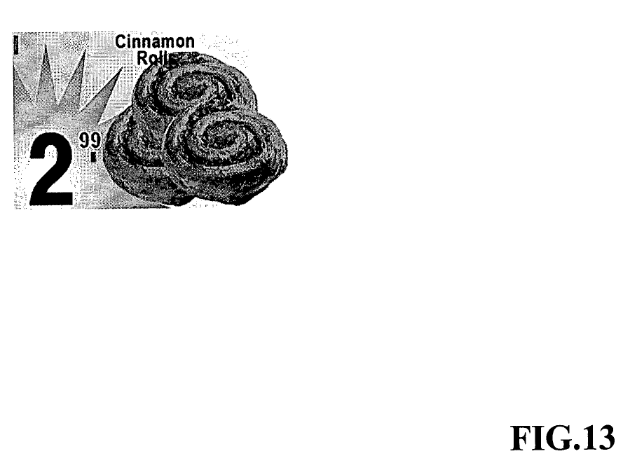

Sometimes it is desired to maximize a size of an object scaled within the frame. As seen in FIG. 12, for example, the larger rolls make a more enticing advertisement image. Nevertheless, the present inventors have recognized that the indiscriminate increasing of the graphical or text object's size can, in many situations, lead to undesirable consequences. For example, in FIG. 13, the enlarged cinnamon roll clashes with the labeling text reducing its readability. Furthermore, in FIG. 13, the cinnamon roll also clashes with the price on the “price explosion” object.

Thus, while having a larger object scale can increase the score, other factors, such as overlap between the object and non-target objects within the frame (e.g. price explosion object 305, labeling text 306) can either reduce the score (e.g. reduce the desirability of a configuration with these properties) or can be eliminated without being officially scored.

In some embodiments, a plurality of putative configurations of the target graphical object are scored and/or eliminated (configuration includes position within the frame, scaling and optionally orientation), and the highest scoring configuration is selected. The target object is layed out in the selected configuration within the bounding frame.

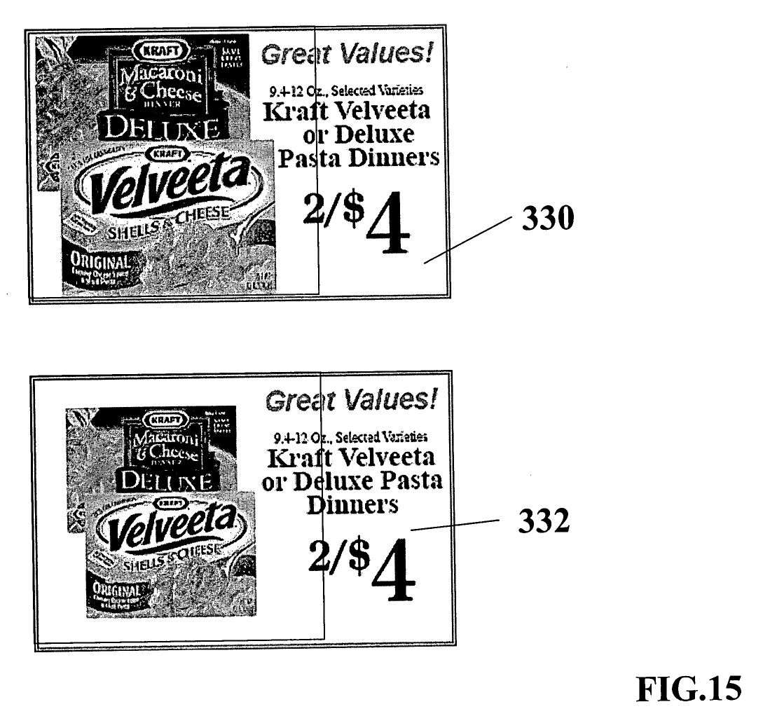

Below is a list of parameters used to score putative layout configurations of the target object. The best fit algorithm is using the following set of rules (e.g. scoring rules and/or elimination/rejection rules for eliminating a putative configuration).
a) Rejecting rule—Text objects with non transparent background can overlap with the image.
b) Rejecting rule—Defining objects that image can overlap with and objects that can overlap up to a certain amount. If the amount of overlap is above the permitted threshold, the solution is rejected.
c) Analyzing the overlap value between the target object and other non-target objects. A greater overlap value reduces the score, (e.g. reduces the desirability of this layout), and a lesser overlap increases the score.
d) Scoring rule—Ventillation of the target object is analyzed. Configurations with a greater “ventiallation” awarded greater score (e.g. though the total score may descrease due to other factors, such as smaller image, etc).
e) Analyzing the distance between the weighted center of the image and the weighted center of the free frame, awarding the configuration of the image where that distance is minimized a higher score.
f) a rule to prefer a greater size (e.g. to award a higher score for greater size though not necessarily a higher total score). Thus, as shown in FIG. 15, a larger image 330 (e.g. cheese products) is preferred over a smaller image 332—e.g. makes a more effective advertisement.

As used herein, a “ventilation parameter” of a target object for a given configuration of the target object within a bounding frame (e.g. a given scaling, a given orientation, a given location) is calculated by slightly increasing the scale of a dimension (or both dimensions) (e.g. increasing by at least about 3% and at most about 7%) of the target object and measuring the value of the overlap of the enlarged target object with non-target objects in the frame. The overlap of the enlarged target object is the ventialation parameter. In general, configurations with more ventilation (e.g. smaller ventilation target parameters) are prefer because then the ad appears less crowded.

Some embodiments of the present invention relate to a “free frame” of the bounding frame. The free frame of the target frame is the subspace of the interior of the bounding frame that is not occupied by non-target objects. The “central location” or “center” of the free frame is the average or central position of the “free frame.”

A “free frame layout parameter” of a configuration (e.g. a putatitive configuration including a position within the frame) of a target graphical object is defined as a “a relation between a central location (e.g. a center) of the free frame and a central location (e.g. a center) of the target graphical object.”

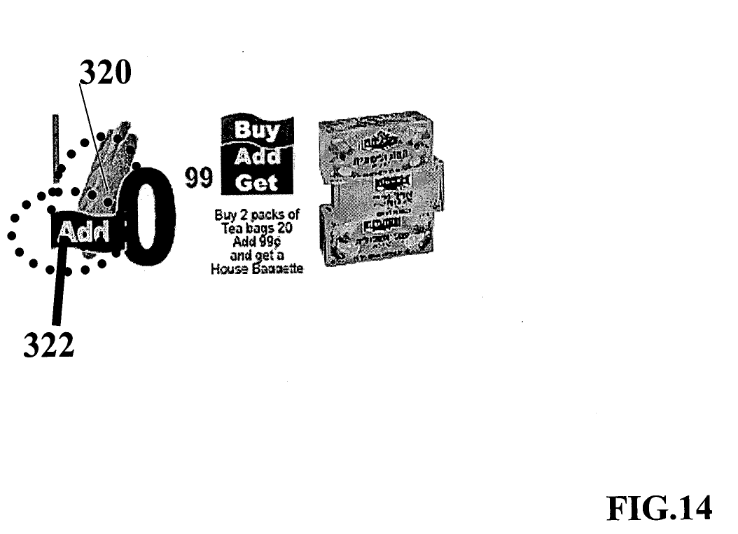

FIG. 14 displays an example of where “text with a non-transparent background” 322 overlaps with a graphical object 320. In some embodiments, overlap of “text with a transparent background” (e.g. cinnamon rolls of FIG. 13) with another graphical object (e.g. the target object is the text and the “other” graphical object is a non-target object AND/OR the target object is the “other” graphical object and the text is a non-target object) reduces “best fit” score.

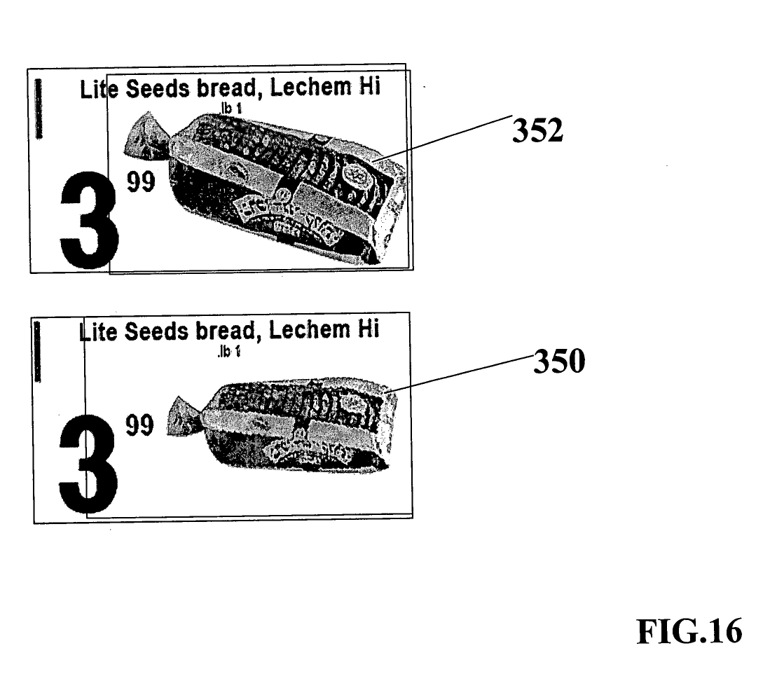

In some embodiments, the target object has a default orientation within the frame (e.g. a default orientation specified, for example, in a “model” outer frame or placeholder). Thus, it is desired for this object to retain this orientation. Thus, although when examining possible layout configurations the target object may be allowed to deviate from the default orientation (e.g. to allow for a larger scale with more ventilation (e.g. smaller ventilation parameter) or less overlap), in some embodiments, the deviation from default orientation is punished with a smaller score (though not necessarily a smaller overall score). This is illustrated in FIG. 16 wherein the “default orientation” image of bagged bread 350 has a smaller bread image than the slightly rotated image 352, where the bread is enlarged. Thus, according to the example of FIG. 16, the rotation of 325 of FIG. 16 results in a lower score which is offset by the higher score due to an enlarged image. Thus, according to FIG. 16, image 352 is preferred despite being oriented.

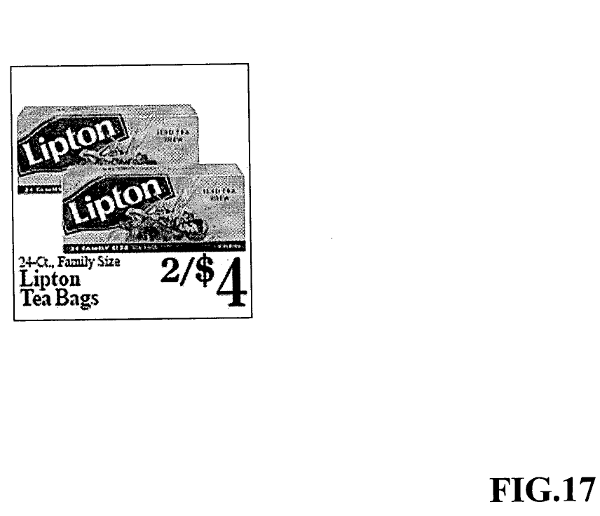

FIG. 17 provides an image of an “unbalanced ad” (balance from top to bottom rather than from left to right) where too much space is left at the top of the ad. The ad content (e.g. the images of the text box) should have been drawn upwards. In some embodiments, ad “balance” is used to score a configuration of a target object (graphical or text).

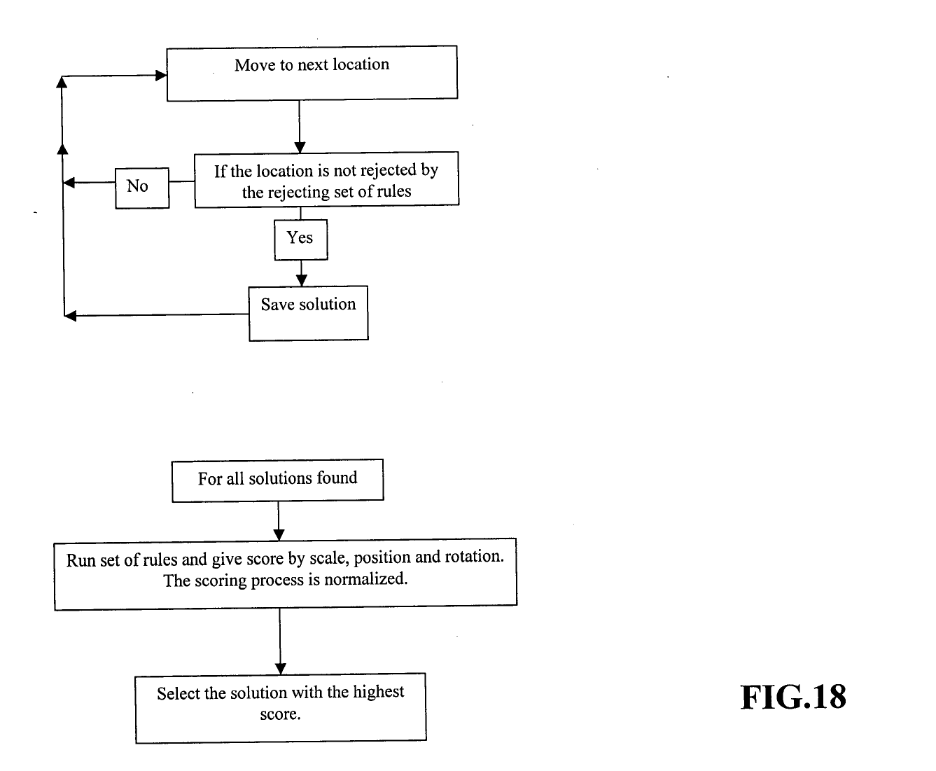

FIG. 18 provides a flow chart of an exemplary technique for examining a plurality of putative layout configurations and selecting a “solution” for actual layout.

Additional exemplary embodiments of the present invention will now be further discussed below, and definitions in accordance with these additional embodiments will be presented, without in any way limiting any embodiments already discussed. These exemplary embodiments are presented for illustrative purposes only.

### DISCUSSION OF ADDITIONAL EMBODIMENTS OF THE PRESENT INVENTION

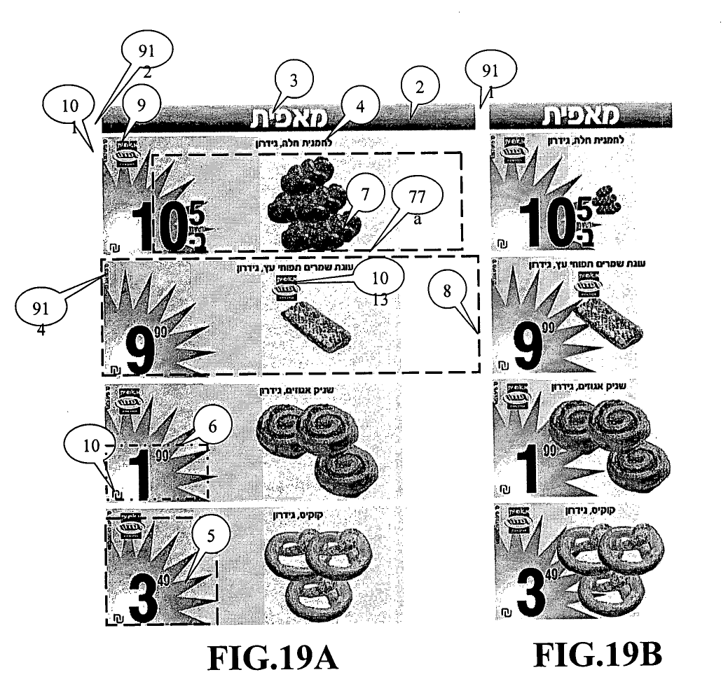

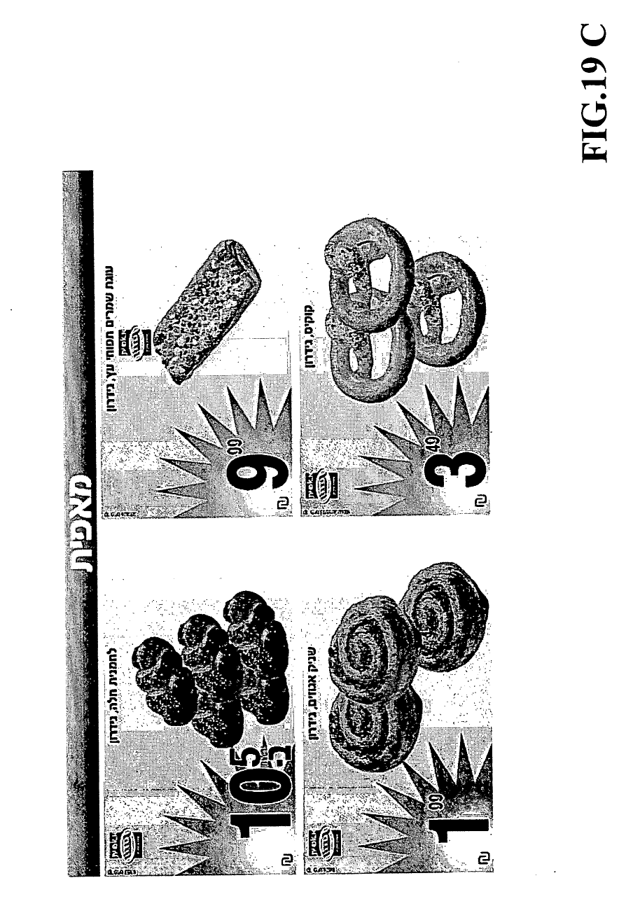

FIG. 19 shows various product oriented ads with different size of the ad or the page, and where design rules are kept. The figure shows 3 (A, B, C) different sizes of the same 4 ads made as result of resizing algorithm based on an embodiment of the current invention with the resize parameters applied to each layout element.

It is noted that FIG. 19A and FIG. 19B have identical dynamical layout templates, and differ in the specified dimensions of the external frame containing the add—in some cases, this external frame is an entire page, but it doesn't need to be.

The dynamic layout template of FIG. 19C specifying the layout of elements within a given single ad cell is the same as that of FIGS. 19A-19B. However, the dynamic layout template specifying the placement of the 4 ads relative to each other is differs in 19C from that provided in 19A and 19B, wherein in 19C the dynamic layout template specifies ads placed in a 2×2 configuration, while the dynamic layout template of 19A-19B specifies ads placed in a 1×4 configuration.

The resize parameters are identical throughout 19A, 19B and 19C. The only difference is the size of the external frame, and in the case of 19C, the size of the external frame and one level of dynamic layout template, namely subpage level.

It is noted that between FIG. 19A and FIG. 19 B only the X dimension of the outer layout frame was changed; between FIGS. 19A and 19C both the X and the Y dimension of the outer layout frame was changed. Thus, certain vertical Y resize parameters do not necessarily effect a change between FIG. 19A and FIG. 19B, even if these resized parameters are defined as such; however, between FIG. 19A and FIG. 19C, wherein the vertical Y dimension of the outer layout parameter does change, the influence of these vertical Y resize parameters are evident.

FIG. 19A shows a sub-page in a free standing insert of a food-chain, related to the bakery department with 4 ads (1 . . . 4 from top to bottom).

FIG. 19B shows the same sub-page resized to a larger facing area for the bakery department.

FIG. 19C shows the same sub-page resized to a different facing area with different arrangement of the ads within the sub-page, layout changes must be made again once the size of the sub-page or the grid arrangement of the ads within the sub-page is determined by a user or the application.

The Origin of the sub-page and the origin of every ad for the Example of FIG. 19 are considered to be the upper left corner

Description of the Balloons

Transformation of Content from FIG. 19A to FIG. 19B

Balloon no 1: Sub-Page (Such as the Sub Page Provided in FIG. 19A or FIG. 19B)

Transformation from FIG. 19A to FIG. 199B Proportional scale XY on frame (e.g. the size of the frame of FIG. 19A is proportionally scaled in two dimensions according to the size of it container meaning the page)

Balloon no 2: Sub-Page Header Background Frame

Transformation from FIG. 19A to FIG. 199B Delta X scale

Please note that the size of the “gutter” balloons 11,12 or white space between outside of the frame and the element defined by balloon 2 remain constant between FIG. 19A and FIG. 19B. Within this framework, the sub-page header background frame is scaled in the X direction only (Delta X scale) so that it fills the area between the two gutter white spaces.

Balloon no 3: Sub-Page Header Title

Transformation from FIG. 19A to FIG. 19B Move/shift proportional, No scale, meaning that the size of the sub page header title is preserved; the “proportional X position” of the center of the sub-page header title is preserved within the frame defined by balloon 1, though the X component of the absolute distance between a fixed reference point outside of the sub-page header title (such as the upper left corner of the frame) and the center of the sub-page header title changes as the sub-page is scaled.

Balloon no 4: Title of ad no 1

Transformation from FIG. 19A to FIG. 19B move X proportional, no scale meaning that the size of the ad title is preserved; the “proportional X position” of the center of the title of ad no 1 is preserved within the frame defined by ad frame-balloon 8, though the X component of the absolute distance between a fixed reference point outside of the title of ad No 1 (such as the upper left corner of the ad frame 8) and the center of the title of ad no 1 changes as the sub-page containing the ad is scaled.

Balloon no 5: Graphic that Shows Explosion

Transformation from FIG. 19A to FIG. 19B, No scale; no absolute delta x or delta Y movement.

Balloon no 6: A Placeholder for Pricing Details that are Part of a Lower Level Template

Transformation from FIG. 19A to FIG. 19B No scale; no absolute delta x or delta Y movement.

Balloon no 7, 7a: Product Image of ad no 1, Image Frame for ad no 1

Transformation from FIG. 19A to FIG. 19B Move/shift proportional XY,

Scale frame proportional XY
Scale content to best fit in its frame
   Balloon no 8: Ad Frame with Tapered Background Profile (in Color Figure only)—
   Transformation from FIG. 19A to FIG. 19B scale delta x, according to the placeholder for that ad which is contained in the sub-page-balloon no 1.
   Balloon no 9,13: Company Logo for ad no 1 with 2 Placeholders, One Near the Top Left Corner of the ad Frame, and One at the Horizontal Center Below the ad Title, each of this Placeholders have Different Treatments
   Transformation from FIG. 19A to FIG. 19B—Balloon No 9—No move, No Scale—this element retains its absolute size and its absolute position relative to a fixed reference point such as the top left corner of the Ad frame (Balloon No 8).
   Balloon No 13—no scale, move/shift proportional on X in order to keep Logo positioned in the horizontal center of the ad frame
   Balloon No 10: Currency Signs for ad no 1—
   Transformation from FIG. 19A to FIG. 19B No move, No scale—this element is part of the content of the “Pricing Details Model” which is a lower level layout element in the document hierarchy. The currency sign retains its absolute size and its absolute position within the “Pricing Details Model” which is a fixed size layout element. The “pricing details model” is placed on the placeholder (balloon 6) with align to the bottom left corner of the place holder, contained in the ad model (balloon 8)
   Balloon no 11, 12: White Spaces Between Sub-Page Header Background and Sub-Page Frame
   Transformation from FIG. 19A to FIG. 19B, the white spaces are left constant as a result of the scale delta x of the sub-page header background (balloon no 2) according to its container (balloon no 1) the sub-page
   Balloon no 14: Part Number of the Product in the ad

Transformation from FIG. 19A to FIG. 19B, no scale, no move—keep the position on the left side of the ad

Table of resize parameters for the Ad level in a document that have a hierarchy including but
not limited to Page, Sub-Page, Ad, Place holder in the ad

| | | | Scale | | | | |
|---|---|---|---|---|---|---|---|
| Balloons | Label | Move | Origin | Scale | Contens | Stroke | Align |
| 9 | Logo1 —alternative place for another | None | NA | None | No | No | 5 |
| | logo | | | | | | |
| 13 | Logo2 —alternative place for another | %_X | NA | None | No | No | 5 |
| | logo | | | | | | |
| 6 | Place holder for “Pricing Details | D_Y | NA | None | No | No | 7 |
| | Graphic Model) | | | | | | |
| 14 | Ad_PartNo | None | 1 | D_Y | No | No | 1 |
| 4 | Ad_Descr | None | 1 | D_XY | No | No | 2 |
| 5 | Fig_Background1 | D_Y | NA | None | No | No | 7 |
| 8 | FIGURE | None | 1 | D_XY | No | No | 1 |
| 7, 7a | Image & Place holder for “Image” | None | 1 | D_XY | yes | No | 5 |

| | |
|---|---|
| 1, 2, 3 | Are part of the Sub-Page level which is a one higher hierarchy above Ad level, in the |
| | document and |
| | thus are not part of the ad resizing parameters table |
| 10 | Is part of Pricing Details Graphic Model, Which is a lower level in the hierarchy and thus |
| | is not part of the ad resizing parameters |
| 11, 12 | Are space that will be kept constant under the resizing transformation |
| 7 | Shows a result of second stage content sizing algorithm that take place after the first step |
| | “frame sizing and positioning” of the image frame, the second stage enlarge the image |
| | within the image frame, to its largest available space without intersecting other |
| | objects in the ad according to the image internal boundaries, within the |
| | resized image frame |

Align the content within its placeholder frame and specifying origin point for scale transformation of placeholder frames in the above table is by using the following convention

| | | |
|---|---|---|
| 1 | 2 | 3 |
| 4 | 5 | 6 |
| 7 | 8 | 9 |

Transformation of Content from FIG. 19A to FIG. 19C
Please note that in FIG. 19A the dynamic template of the subpage level has grid containing 4 rows, 1 column; in FIG. 19C the dynamic template of the subpage level has grid containing 2 rows, 2 columns.
Balloon no 1: Sub-Page (such as the Subpage Provided in FIG. 19A or FIG. 19C)
Transformation from FIG. 19A to FIG. 19C Proportional scale XY on frame & Content (e.g. the size of the frame of FIG. 19A is proportionally scaled in two dimensions)
Balloon no 2: sub-Page Header Background Frame
Transformation from FIG. 19A to FIG. 19C
Please note that the size of the “gutter” or white space between outside of the frame and the element defined Ballon 2 remain constant between FIG. 19A and FIG. 19C. Within this framework, the sub-page header background frame is scaled in the X direction only (Delta X scale) so that it fills the area between the two gutter white spaces.
Balloon no 3: Sub-Page Header Title
Transformation from FIG. 19A to FIG. 19C Move/shift proportional, No scale, meaning that the size subpage header title is prerserved; the “proporitional X position” of the center of the sub-page header title is preserved within the frame defined by balloon 1, though the X component of the absolute distance between a fixed reference point outside of the sub-page header title (such as the upper left corner of the frame) and the center of the sub-page header title changes as the sub-page is scaled.
Balloon no 4: Title of ad no 1
Transformation from FIG. 19A to FIG. 19C move/shift proportional, no scale meaning that the size of the subpage header title is preserved; the “proportional X position” of the center of the title of ad no 1 is preserved within the unit cell defined by that particular product, though the X component of the absolute distance between a fixed reference point outside of the title of ad No 1 (such as the upper left corner of the frame) and the center of the unit cell changes as the sub-page is scaled.
Balloon no 5: Price Related Graphic of ad no 1 (Shows Explosion)
Transformation from FIG. 19A to FIG. 19C Move/shift delta Y, No Scale—note that the absolute size of the graphic is preserved; similarly, the absolute distance of the center of the price related graphic relative to ONE reference point, namely the lower left point of the unit cell defined by that particular add is also preserved; nevertheless, the Y component of the distance between the center of the price related graphic relative to ANOTHER fixed reference point, namely the upper left corner of the frame defined by balloon 1, changed from FIG. 19A to FIG. 19C.
Balloon no 6: Promotion Pricing Details of ad no 1
Transformation from FIG. 19A to FIG. 19C Move/shift delta Y, No scale—note that the absolute size of the graphic is preserved; similarly, the absolute distance of the center of the promotion price relative to ONE reference point, namely the lower left point of the unit cell defined by that particular add is also preserved; nevertheless, the Y component of the distance between the center of the promotion price relative to ANOTHER fixed reference point, namely the upper left corner of the frame defined by balloon 8, changed from FIG. 19A to FIG. 19C.
Balloon no 7: Product Image of ad no 1
Transformation from FIG. 19A to FIG. 19C Move/shift proportional XY,
Scale frame proportional XY
Scale content to best fit in it frame
   Balloon no 8: Ad Background Frame for ad no 1
   Transformation from FIG. 19A to FIG. 19C-Scale Delta XY
   Balloon no 9: Company Logo for ad no 1
   Transformation from FIG. 19A to FIG. 19C—No Move, No Scale—note that the absolute size of the company logo is preserved; similarly, the absolute distance of the center of company logo relative to ONE reference point, namely the upper left point of the unit cell defined by that particular add is also preserved; nevertheless, the Y component of the distance between the center of the company logo relative to ANOTHER fixed reference point, namely the lower left corner of the frame defined by balloon 8, changed from FIG. 19A to FIG. 19C.
   Balloon No 10: please note that the currency symbol designated by balloon number 10 is contained in the inner layout frame defined by balloon number 6; the layout frame of balloon number 6 is a contained in the inner layout frame identified by balloon number; The frame designated by Balloon number 6 has the resize parameters move/shift delta Y, no scale within the frame designated by balloon number 8. Thus, from FIG. 19A to FIG. 19C, the entire frame designated by balloon number 6 moves vertically down relative to the upper left hand corner of ballon number 8.
   The resize parameter of the currency symbol designated by balloon number 10 within the frame designated by balloon number 6 is no move no scale; thus, the currency symbol designated by balloon number 10 maintains its vertical and horizontal position within the frame designated by balloon number 6 between FIG. 19A and FIG. 19C; however, because the currency symbol designated by balloon number 10 is contained in the layout frame designated by balloon number 6, and because the entire layout frame designated by balloon number 6 moves vertically down relative to the upper left corner of the layout frame designated by balloon number 8 from FIG. 19A to FIG. 19C, the currency symbol designated by balloon number 10 moves vertically down on the page from FIG. 19A to FIG. 19C.
   Balloon no 11, 12: White spaces (gutter) between sub-page header background and sub-page frame Transformation from FIG. 19A to FIG. 19B, the white spaces are left constant as a result of the scale delta x of the sub-page header background (balloon no 2) according to its container (balloon no 1) the sub-page
   Balloon No 13—no scale, move/shift proportional on X in order to keep Logo positioned in the horizontal center of the ad frame
   Balloon no 14: Part Number of the Product in the ad
   Transformation from FIG. 19A to FIG. 19C, no scale, no move—keep the position on the left side of the ad
   Additional Definitions
   Layout Template: data specifying placeholders (location) and size for which graphical elements are to be sized and placed within a layout frame. Graphical elements include but are not limited to pictures and text. Optionally, layout templates also include font style and size information, text color information, white space or gutter color information, gutter size information, background color information.
   It is noted that in some embodiments, at least one graphical element may itself be a layout template (internal layout template), contained within the “external layout template, and the internal layout template provides information specifying placeholders (locations) and sizes for graphical elements within the internal layout template.
   Static Layout Template: a template wherein actual graphical elements are placed within a layout frame as specified in the Layout Template.
   A layout frame is closed region within which graphical content is to be sized and placed. In some specific embodiments, the layout “frame” is not rectangularly shaped.
   Dynamic layout Template: a template wherein the actual graphical elements are placed within a layout frame as specified in a layout template in conjunction with resize parameters.
   In some embodiments, this dynamic layout template is defined as such specifically by user or computer program. In other embodiments, this dynamic layout template is extracted from a final graphic media document such as an advertisement. Thus, certain embodiments of the invention provide for resizing of graphical and textual elements within a final graphical media document such as an advertisement without explicitly defining the dynamic layout template.
   Layout: an arrangement that includes at least the size and the position of one element
   Layout element: An element of an advertisement that its size or location effects the final advertisement.
   In certain embodiments, a layout element can contain other children layout elements, A layout element is contained in other parent layout element.
   Sample of layout elements are screen, form, page, grid, sub-page, ad, image, logo, text, graphic, header, footer, table, placeholder etc.
   Optionally, at least one layout element serves as a root (most likely the “page” under the publication)
   Dynamic Layout: A layout in which the size or location of at least one of the layout elements is optionally dynamically changed.

As used the term “look and feel” describes a consistency recurring of visual patterns or motifs on a page or throughout a plurality of pages. According to particular embodiments, human observers will notice that the sum aggregate of these motifs endows a printed page or computerized page with a certain appearance. Exemplary visual motifs include, but are not limited to placement of certain recurring graphical or textual items relative to each other both within a cell; a consistency of font sizes or styles, particularly related to a repetition of certain visual elements such as title bars, gutter areas devoid of text and/or graphics; page number placement, font, color and size; Logo, Icon or alike. More particularly, exemplary visual motifs include a pattern wherein the font size of the price of all items on a page or in a plurality of pages is the same or almost the same irrespective of the size of the item whose price is represented or the size of the unit cell in which the price appears; a pattern wherein a header text or footer text is always centered the same way or almost the same way among different regions, each region containing its own header or footer; a size consistency among graphical logos between unit cells of different size or wherein the size consistent graphical logos are juxtaposed next to other graphical images that vary in size; a gutter width that is consistent throughout a page or a sub page.

In accordance with some aspects of the present invention, it has been found that resizing various graphical and textual objects in graphical media, and altering the layout of specific graphical and textual elements while retaining certain visual motifs allows the altered graphical media to retain a visual layout with consistent graphical qualities or “look and feel qualities.” This in turn enables a single design to be implemented in a plurality of documents with different specific parameters such as number of adds per page, size of adds, size of page subsections, page size, etc. This obviates the need for human graphical designers to redesign each single page.

Embodiments of the present invention generally relate methods, systems and computer readable code for the automated and semi-automated layout (sizing and positioning) of elements in visual media including graphical layout elements, including advertisements. In certain embodiments, the layout is performed according to a specified dynamic template or existing ad, where the final result might be in different size from the specified dynamic template or from the existing ad, and there is a need to preserve the original look & feel of the creative art-work made by a human designer that created the template or the existing ad.

In particular embodiments, the invention provides a set of parameters that the designer can supply with a creative art-work or template, in order to enable automatic layout of final advertisement according to the above mentioned template and dynamic size requirements.

In particular embodiments, the above mentioned parameters are calculated from existing samples of artwork or template in different sizes.

While certain specific resize and other layout altering parameters are revealed herein, it is now disclosed for the first time that the process of deriving appropriate parameters is in itself automatable by instructing a computer to characterize physical parameters of graphical motifs, and then to use statistical or machine learning means for recognizing patterns for recurring motifs. Exemplary statistical or machine learning techniques include but are not limited to neural networks, expert systems, decision trees and markov models.

The current invention describes parameters denoted as “resize parameters” that enable to automatically change the size and the location of layout elements in graphical design media (such as an advertisement or a web page) in order to automatically adjust the graphical design media to altered external dimensions. In this way one can accommodate an advertisement to a new page size or to a new partition of the page into sub-pages or to a new layout of each sub-page and hierarchically go down to the ad level in a sub-page, the items level in an ad etc.

Embodiments of the present invention provide “resize parameters” designating scale and move transformations that can be applied to layout elements, each transformation is for certain embodiments applied independently on each dimension of the layout element,

In exemplary embodiments, the scale transformation is applied independently on the:

bounding-frame of layout element
The stroke of the layout element
The content of the layout element
   In some embodiments, the Move transformation effects only the position of the layout element as a whole
   Other exemplary transformation specified by resize parameters include, but are not limited to:
   Appling the scale to the bounding-frame affects its size
   Appling the scale to the stroke affects the stroke width
   Appling the scale to a content of a layout element will affect the content according to the type of the content; if the content is a parent that has other layout elements as children then the treatment on each child would be according to the resize parameters of the child in respect to the change made to the parent.
   The result of a change on a specific child depends on the type of that element, different methods are taken for each type of element.
   If the layout-element is a text frame then, according to exemplary embodiments, resize parameters may be provided which allow for the:
   Resizing the bounding-frame will result is rearranging the text within the frame without changing font-size, line-height or any other scaling parameters.
   Resizing the stroke will affect stroke width
   Resizing content will affect font-size, line-height and other scaling parameters
   If the layout-element is an image frame then according to some embodiments, resize parameters may be provided which allow for the:
   Appling the scale to the bounding-frame affects its size
   Appling the scale to the stroke affects the stroke width
   Appling the scale to the content will result in a proportional scale to the image to fit in the bounding frame.
   In some embodiments, the present invention optionally provides an algorithm that seeks to maximize the size a graphical element within its bounding frame such that the graphical element does not overlap another graphical or text element, and such that the graphical element does not overflow the bounding frame in which it is contained.
   If the layout-element is a graphic frame then according to some embodiments, resize parameters may be provided which allow for the:
   Appling the scale to the bounding-frame affects its size
   Appling the scale to the stroke affects the stroke width
   Appling the scale to the content will result in a scale to the graphic according to the resize parameters of the each layout elements in that graphic
   According to some embodiments, applying the move transformation to a parent layout element that has children will move the parent with its children as a group.
   According to some embodiments, the transformation is applied independently as a Delta Change or Proportional Change as above mentioned
   It is also noted that according to some embodiments, there are layout elements that will not be affected by the transformation.
   According to some embodiments, graphical design media dimensions include but are not limited to X, Y, Z coordinates as well as time or other dimensions depending on the advertisement nature such as X, Y in printed 2D ad or X, Y, Time in animated or video clip ad.
   According to some embodiments, transformations on a layout element are carried out by using a resize parameter that controls the direction of the change. For the scale transformation the resize parameter might define origin as a corner or a middle of a side of the element, so the designer controls to which direction element will change and which corner or side will not move.—Other origins might be used as well in a manner of X, Y coordinates.
   According to some embodiments, the transformation is applied to a template of an advertisement or to a final advertisement.
   In some embodiments, a graphical element contained within an inner layout container is resized and moved according to the resizing parameters of the inner layout container within it outer layout container. In some embodiments, a graphical element contained within an inner layout container is resized and moved according to the resizing parameter scaled by an optional factor of the inner layout container within its outer layout container.

Other way to implement such approach is to create all the design models at the smallest predictable size, and then all the resizing parameters above mentioned are effecting grow change and not shrink changes. In that way it will be easier to the designer to specify the resize parameters.

According to some embodiments of the present invention, different resize parameters are applied according to different ranges of size change of the container.

According to some embodiments of the present invention, the required above mentioned parameters are calculated automatically (instead of been entered by the designer) from 2 or more variants of the same advertisement where each variant is in a different size. This can be done by assigning a label to each layout element, so the system can track what are the changes in that affected each layout elements in each variant according to its size. The system then will categorize and quantify the changes according to the same parameters as above mentioned. An example of such variants of the same advertisement is provided in FIG. 19A and FIG. 19C.

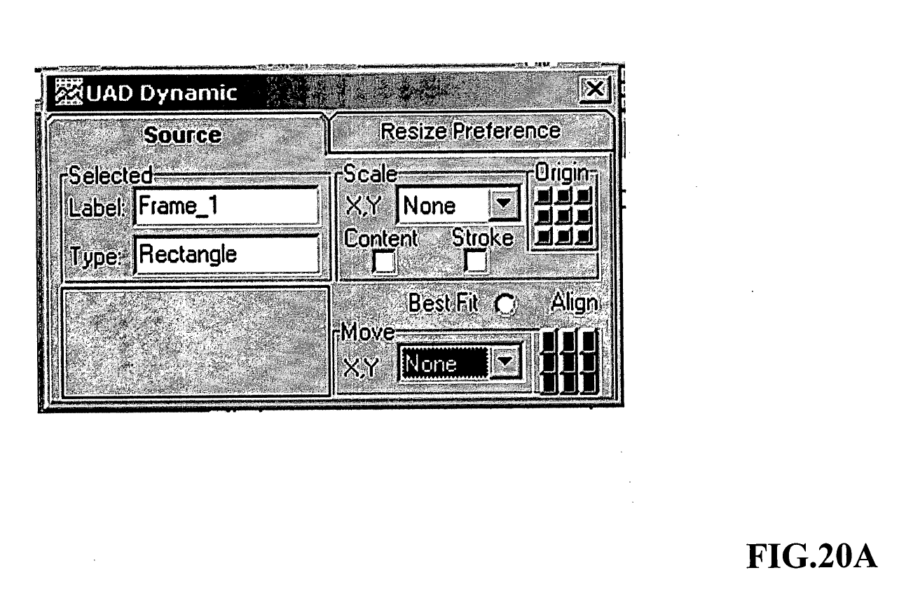

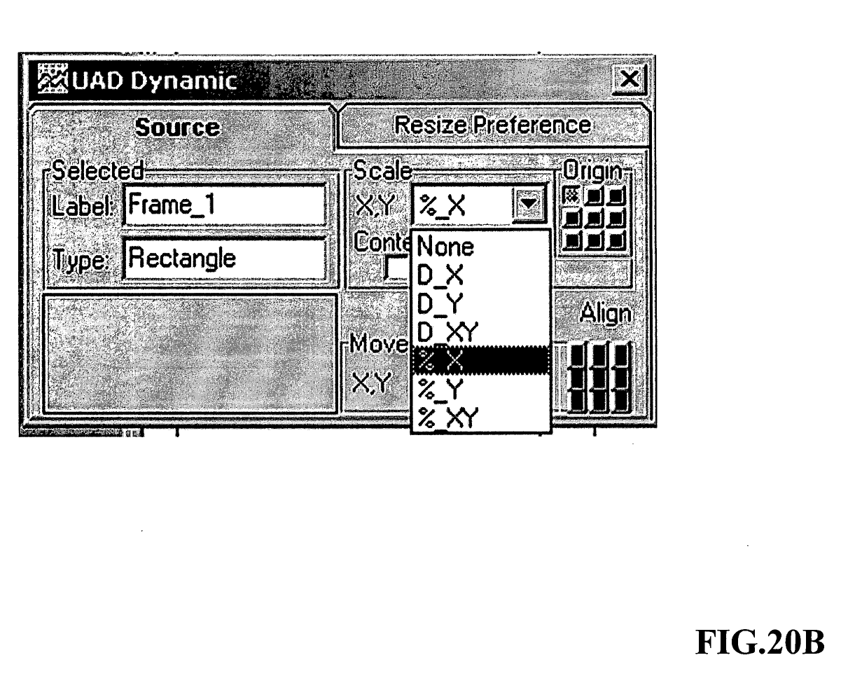

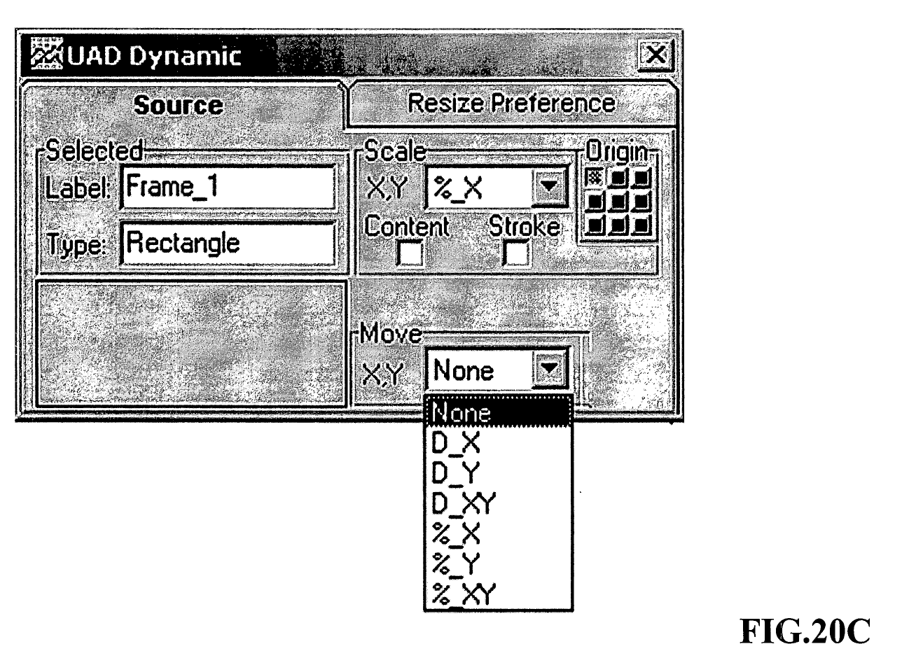

FIG. 20 provides images of menus for a user to input exemplary resize parameters to be applied to specific graphical elements to be laid out within a graphical layout frame.

FIG. 20

FIG. 20A shows such dialog box integrated into a graphic layout application

FIG. 20B shows a list of different alternatives for scale transformation that the algorithm will take when resizing the layout element

FIG. 20C shows a list of different alternatives for move transformation that the algorithm will take when resizing the layout element

D_X stand for Delta X—Delta change on the X axes as the change to the container

D_Y stand for Delta Y—Delta change on the Y axes as the change to the container

D_XY stand for Delta X and Delta Y—Delta change on the X and Y axes as the container

None indicates that no scale transformation is required for that layout element, when the container size is changed

Similarly—% instead of D will define that a proportional change is required instead of a Delta change

The “Content” check box, and the “Stroke” check box will indicate if content or stroke resize are required or not.

At FIG. 20C the parameters effects the move transformation of the layout element X,Y position in respect to its container

In some particular embodiments, one or more similar graphical media documents such as advertising flyers may be constructed from a single graphical media document by user inputted resizing parameters and/or other layout parameters.

In some particular embodiments, the resizing parameters and/or other layout parameters characterizing the transformation between two graphical media documents may be implicitly derived upon receipt of the two graphical media documents.

It is now revealed for the first time a method for the automatic or semiautomatic production of a plurality of page layouts derived from a single page or document containing graphical media.

In exemplary embodiments, the present invention provides methods for the automatic creation of a page layout in a tabloid size free-standing-insert of a food chain. In such advertisements, the page might be partitioned to several sub-pages that accommodate several departments on the page. The size of each sub-page and each ad in the sub-page may be determined according to the number of ads in the relevant department, according to the number of columns or rows of the grid, the gutter width, the facing area of a department, titles headers, footers, ad model etc.

It is understood that embodiments of the present invention are equally applicable to graphical media other the advertising flyers including product catalogues, e-commerce sites, and corporate web sites.

According to certain embodiments, the user provides one or more templates characterizing one or more layout elements.

In particular embodiments, the user provides one or more templates from which a graphical media document is produced. In specific documents, the content of these templates are electronically stored in memory or on a storage media in a specific file format reflecting the program in which the template is created. Subsequently, a file is parsed, or the data structures representing the template are recreated, and appropriate transformations are applied to one or more templates to produce a graphical media document.

Specific embodiments of the present invention provide for receiving user-provided data or parameters from a dialog box embedded in the user interface of layout applications such as AutoCAD, Adobe Indesign, FreeHand, Quark xpress, Pagemarker etc. and to enable the user to define resizing and other layout parameters as described herein.

It is noted that in specific embodiments, layout elements are defined in a hierarchical form, wherein layout elements contain other layout elements. In one specific embodiment, a transformation based on resize and/or other layout parameters specified for a first layout element is recursively applied to layout elements contained in the first layout elements. In other embodiments, a given layout elements adapts the resize and/or other layout parameters of its parent layout element as a default setting. In further embodiments, the user is given an opportunity to override the default setting with a user provided resize and/or other layout parameter. In further embodiments, the resize and/or other layout parameters are provided as a result of a statistical or expert system calculation.

In specific embodiments, the present invention provides for the automatic detection of illegal resize parameters, and optionally provides for alerting the user of illegal resize parameters. Optionally, an embodiment of the present invention calculates illegal resize parameters, and through the user interface precludes the option of entering illegal resize parameters.

According to some embodiments, the present invention provides a method of sizing and placing a plurality of graphical elements in an external layout frame, the method comprising:
a) providing a plurality of graphical elements;
b) providing the dimensions of the external layout frame;
c) providing a dynamical layout template, the dynamic layout template specifying the location and size of graphical elements within said layout frame;
d) providing a set of resize parameters, said resize parameters describing location and size transformations of graphical elements within said layout frame;
e) placing and sizing at least some said graphical elements within the external layout frame according to said provided dynamical layout template and said resize parameters, wherein the external layout frame is sized according to said provided dimensions.

According to some embodiments, at least one said graphical element includes an internal layout frame associated with at least one internal graphical element, at least one internal layout template and optionally at least one internal resize parameter.

According to some embodiments, said internal layout template is a dynamical layout template.

According to some embodiments, the method further comprises placing and sizing at least one said internal graphical element within said internal layout frame according to said internal layout template and at least one said internal resize parameters.

According to some embodiments, external dynamic layout template or one said internal dynamic layout template is obtained by providing a set of external grid parameters, and fashioning said external dynamic layout template according to said grid parameters.

According to some embodiments, the external layout frame is part of a printed document.

According to some embodiments, the printed document is selected from the group consisting of product catalogue, advertising flyer, product catalogue, freestanding insert, shelf advertisement, in store signs, email newsletters, and advertising flyer.

According to some embodiments, the external layout frame is part of one or more web pages.

According to some embodiments, the external layout frame is displayed on a computer screen.

According to some embodiments, the resize or internal resize parameters are selected from the group consisting of absolute translation of location (move transformation/delta changes), relative translation of location within the external layout frame, a proportional change specifying a change in element size or aspect ratio, an absolute change specifying a change in element size or aspect ratio, a command to leave an element of the same size even when said dynamic template is resized, a command to apply a dynamic template resize to stroke width, a command to not apply dynamic template resize to stroke width, a command to align certain graphical or text elements or layout frame with other graphical or text elements or layout frame, a command to align certain graphical or text elements or layout frame in an absolute position within an external layout frame, a command to align certain graphical or text elements or layout frame in an relative position within an external layout frame.

According to some embodiments, the translations of location are relative to an origin.

According to some embodiments, the origin is affixed to said external layout frame.

According to some embodiments, said fixed origin is selected by a user.

Exemplary embodiments of the present invention provides for producing more than one version of page layout according to a plurality or page dimensions and/or dynamic layout templates.

According to some embodiments, updated dimensions of the external layout frame are provided, and subsequently at least some said graphical elements are sized and placed within the external layout frame according to said provided dynamical layout template and said resize parameters, wherein the external layout frame is sized according to the updated dimensions.

According to some embodiments, an updated dynamic layout template provided, and subsequently at least some said graphical elements are sized and placed within the external layout frame according to said updated dynamical layout template and said resize parameters, wherein the external layout frame is sized according to the provided dimensions.

Embodiments of the present invention provide a method of determining resize parameters for graphical elements sized and placed out within a layout frame comprising:
a) providing graphical elements placed and sized within the layout frame;
b) providing a dynamic layout template, the dynamic layout template specifying the location and size of graphical elements within said layout frame;
   c) determining the resize parameters, said resize parameters indicative of discrepancies between the location and size of graphical elements placed within the layout frame, and the specified locations and sizes of graphical elements within said layout frame.

Embodiments of the present invention provide a method of determining resize parameters for graphical elements sized and placed out within a layout frame comprising:
a) providing a first layout template, the first layout template describing specified locations and sizes of graphical elements within a first layout frame;
b) providing a second layout template, the second layout template describing specified locations and sizes of graphical elements within a second layout frame;
c) determining the resize parameters, said resize parameters indicative of discrepancies between the first and second layout template.

It is noted that the present invention provides machine readable code for implementing any of the methods described herein. In some embodiments, the machine readable code provides user menus for specifying resize parameters and/or layout frames sizes and/or one or more dynamic and/or static layout templates.

According to some embodiments, resize parameters are selected from the group consisting of absolute translation of location (move transformation/delta changes), relative translation of location within the external layout frame, a proportional change specifying a change in element size or aspect ratio, an absolute change specifying a change in element size or aspect ratio, a command to leave an element of the same size even when said dynamic template is resized, a command to apply a dynamic template resize to stroke width, a command to not apply dynamic template resize to stroke width, a command.

According to some embodiments, resize parameters are selected from the group consisting of absolute translation of location (move transformation/delta changes), relative translation of location within the external layout frame, a proportional change specifying a change in element size or aspect ratio, an absolute change specifying a change in element size or aspect ratio, a command to leave an element of the same size even when said dynamic template is resized, a command to apply a dynamic template resize to stroke width, a command to not apply dynamic template resize to stroke width, a command to align certain graphical or text elements or layout frame in a relative or absolute position within an external layout frame.

### REFERENCES

1. A Genetic Algorithm Approach to Automated Custom Document Assembly Lisa Purvis, Xerox Corporation
800 Phillips Road, 128-27E
Webster, N.Y. 14580
2. Hybrid Genetic Algorithms for Constrained Placement Problems, Volker schneche and Oliver Vornberger, IEEE transactions on evolutionary computation, Vol. 1, No. 4, November 1997. pp. 266-277
3. A Survey of Automated Layout Techniques for Information Presentations By Simon Lok and Steven Feiner
Dept. of computer Science
Columbia University, NY
4. Automatic yellow pages pagination and layout, October 1996 R. Johary—Harvard, J. Marks—Merl, A. Partovi—mFactory, S. Shieber—Harvard
5. Adaptive grid-based document layout
Charles Jacobs—Microsoft research, Wilmot Li—University of Washington, David Bargeron—Microsoft research, David Salesin—Microsoft research & University of Washington

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) A system for graphical layout, the system comprising:
a) a model layout interface for defining positions and sizes of a plurality of graphical objects within a model outer frame;
b) a re-size parameter interface operative to define re-size parameters including shift parameters, scale parameters, proportion re-size parameters and delta re-size parameters for each said graphical object; and
c) a layout engine for shifting and scaling said graphical objects within a re-sized outer frame in accordance with at least one dimension of said model outer frame, at least one dimension of said re-sized outer frame, and said defined re-size parameters.

2) The system of claim 1 wherein at least one said graphical object is a placeholder having inner graphical objects embedded therein, and said layout engine is operative to recursively effect a hierarchical re-sizing of said inner graphical objects in accordance with inner re-size parameters of said inner graphical objects relative to said re-sized placeholder.

3) The system of claim 1 further comprising:
d) a reference point interface for defining a reference point of at least one of said model outer frame and said graphical object, wherein said layout engine performs at least one of said shifting and said scaling in accordance with said defined reference point.

4) The system of claim 3 wherein said reference point interface is operative for selecting said reference point from a plurality of discrete reference points.

5) The system of claim 1 wherein said re-size parameter interface is operative to define variable re-size parameters whose value depends on a relation between dimensions of said model outer frame and said re-sized outer frame.

6) The system of claim 1 wherein said layout engine is operative to perform re-sizing of video content.

7) The system of claim 1 wherein one said graphical object is a placeholder having inner graphical objects embedded therein, the system further comprising:
d) a alignment definition interface for defining an alignment of said inner graphical object within said placeholder.

8) The system of claim 1 wherein said layout engine is further operative to layout at least one said graphical object in accordance with layout score and optionally a disqualifier, and said layout score is determined by at least one of an object overlap parameter, a text background transparency status, an orientational deviation between a putative orientation and a default or preferred orientation, ventilation parameter, and a location of a weighted center of said graphical object relative to a center of a bounding frame.

9) A system for layout of a target graphical object within a bounding frame, the system comprising:
a) a layout parameter calculation engine for calculating for at least one putative layout configuration at least one layout parameter selected from the group consisting of free frame layout parameter and a ventilation parameter; and
b) a layout engine for performing a layout of said target graphical object within said bounding frame in accordance with a said calculated parameter.

10) The system of claim 9 wherein said layout parameter calculation is performed for a plurality of putative layout configurations, the system further comprising:
c) selection engine for selecting configurations to score.

11) The system of claim 9 wherein for a given putative layout configuration, said layout parameter calculation engine calculates a plurality of said layout parameters, said system further comprising:
c) a layout parameter combining engine for computing a layout score from said plurality of said layout parameters,
wherein said layout engine performs said layout in accordance with said layout score.

12) The system of claim 9 wherein said layout engine is operative to prefer larger scalings of said target graphical object.

13) The system of claim 9 wherein said layout parameter calculation engine is operative to calculate a re-orientation parameter of the target graphical object within said bounding frame, and said layout engine is operative to re-orient said target graphical object within said bounding frame.

14) The system of claim 9 wherein said layout parameter calculation engine is operative to calculate at least one additional layout parameter selected from the group consisting of an object overlap parameter, a text background transparency status, relative color status of the target graphical object and a background, and said layout engine is further operative to perform said layout of said target graphical object within said bounding frame in accordance with a said calculated additional layout parameter.

15) A system for graphical layout comprising:
a) a model layout interface for defining positions and sizes of a plurality of graphical objects within a model outer frame;
b) a differential layout engine for effecting a re-sizing including shifting and scaling of said graphical objects within a re-sized outer frame in accordance with at least one dimension of said model outer frame and at least one dimension of said re-sized outer frame,
wherein a first group of said graphical objects are re-sized according to a first set of re-sizing parameters, and a second group of said graphical objects are re-sized according to a second set of re-sizing parameters differing from said first set of re-sizing parameters.

16) The system of claim 15 wherein said graphical objects include a first and second placeholder, each said placeholder having a respective group of inner graphical objects embedded therein, each said respective group of said inner graphical objects having a different set of inner re-size parameters, each said placeholder being subjected to a different re-sizing, and said layout engine is operative to recursively effect a hierarchical re-sizing of said respective inner graphical objects within each said respective placeholder in accordance with said respective inner re-size parameters.

17) The system of claim 15 wherein said graphical objects include a first and second placeholder, each said placeholder having respective inner graphical objects embedded therein, each said placeholder being subjected to a different re-sizing, and said layout engine is operative to layout said inner graphical objects within each placeholder in accordance with at least one factor selected from the group consisting of an object overlap parameter, a text background transparency status, an orientational deviation between a putative orientation and a default or preferred orientation, a ventilation parameter, and a location of a weighted center of said graphical object relative to a center of a bounding frame and a relative color status of the target graphical object and a background.

18) A method of graphical layout, the method comprising:
a) defining positions and sizes of a plurality of graphical objects within a model outer frame;
b) defining re-size parameters including shift parameters, scale parameters, proportion re-size parameters and delta re-size parameters for each said graphical object; and
c) shifting and scaling said graphical objects within a re-sized outer frame in accordance with at least one dimension of said model outer frame, at least one dimension of said re-sized outer frame, and said defined re-size parameters.

19) A method of layout of a target graphical object within a bounding frame, the system comprising:
a) calculating for at least one putative layout configuration at least one layout parameter selected from the group consisting of free frame layout parameter and a ventilation parameter; and
b) performing a layout of said target graphical object within said bounding frame in accordance with a said calculated parameter.

20) A method of graphical layout comprising:
a) defining positions and sizes of a plurality of graphical objects within a model outer frame; and
b) effecting a re-sizing including shifting and scaling of said graphical objects within a re-sized outer frame in accordance with at least one dimension of said model outer frame and at least one dimension of said re-sized outer frame,
wherein a first group of said graphical objects are re-sized according to a first set of re-sizing parameters, and a second group of said graphical objects are re-sized according to a second set of re-sizing parameters differing from said first set of re-sizing parameters.
